(19) United States
(12) Patent Application Publication
(10) Pub. No.: US 2005/0106967 A1
(43) Pub. Date: May 19, 2005

(54) Antifouling waterproof sheet

(76) Inventor: Kenji Suzuki, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/497,541

(22) PCT Filed: Dec. 12, 2002
(86) PCT No.: PCT/JP02/13007

(30) Foreign Application Priority Data
Dec. 14, 2001 (JP) 2001-381835

(51) Int. Cl. B32B 27/04; B32B 5/02; B32B 27/12

(52) U.S. Cl. 442/86; 442/93; 442/87; 442/88; 442/94; 442/79

(57) ABSTRACT

A stainproof, waterproof sheet with excellent waterproofing property, rain streaking-preventing property, hot melt bonding property is obtained by forming a water proof resin layer comprising a synthetic resin containing no plasticizer, or a synthetic resin containing a plasticizer and/or a softener, on at least one surface of a base fabric, and then forming thereover a stainproof layer comprising a synthetic resin and fine amorphous silica particles, either with or without an intervening additive migration-preventing layer, and with optional addition of a flame retardant agent to at least one member of the waterproof resin layer, additive migration-preventing layer and stainproof layer.

### TECHNICAL FIELD

The present invention relates to a waterproof sheet with an excellent stainproof property. More specifically, the invention relates to a stainproof, waterproof sheet having excellent waterproofing property, rain streaking-preventing property, weldability and flameproof properties, and highly useful for industrial materials such as medium and large-sized tents, tent storehouses, canopy tents, truck hoods, backlits for signboards, etc.

### BACKGROUND ART

As sheets for industrial materials, for example, medium and large-sized tents, tent storehouses, canopy tents, truck hoods, backlits for signboards, etc., conventionally, processed fabrics in which fiber base fabrics are laminated on one or both surfaces thereof with resin coating layers of synthetic rubber or synthetic resins, are widely employed. Such sheets employing polyvinyl chloride-based resins as the resin coating layer resins are in particularly wide use because of their satisfactory balance among processability, economical advantage, flameproof property and softness. Sheets of this type are used outdoors in most cases, and with extended use their surfaces become stained by contaminating substances such as smoke or soot emitted from factories and automobiles, pollen, sap, or excretions from birds or insects, such that the original aesthetic appearance is degraded. In particular, a sheet having the resin coating layer formed from a polyvinyl chloride resin, even if the composition of the resin is carefully selected to contain large amounts of plasticizer or stabilizer in the composition, will undergo advancing decomposition of the resin under the effects of ultraviolet rays and rain (acid rain) when used for prolonged periods outdoors, or the plasticizer will tend to migrate to the surface, gradually rendering it adhesive and causing it to attract powder and dust, thereby leading to further fouling of the sheet surface. Curtain structures such as tent storehouses constructed using such sheets exhibit notable side streaks (rain streaking) when parts of dirt adhering to the roof side sheet flow down to the sides of the sheet by the force of rainfall, thereby significantly impairing the appearance of the sheet. Cleaning of extensive fouling is particularly difficult in cases involving very large spreading surfaces such as medium or large-sized tents or tent storehouses, and therefore, either they must be used with the impaired appearance or a new sheet must be periodically spread thereover. Demand therefore exists in the industry for sheets with surfaces that are resistant to fouling for prolonged periods.

One method that has been proposed to improve stainproof involves coating an acryl-based resin dissolved in an organic solvent onto the surface of the polyvinyl chloride resin, but an adequate effect has not been achieved because the plasticizer in the organic solvent of the coating resin solution dissolves out, or the liquid plasticizer or liquid stabilizer contained in the polyvinyl chloride resin migrates to the coating resin layer. In such cases, coating of a fluorine-containing resin instead of an acryl-based resin onto the sheet surface (Patent Document 1: Japanese Unexamined Patent Publication SHO No. 60-260333) is highly effective at inhibiting migration of the plasticizer, etc. as compared to acryl-based resin coatings, and also at increasing the barrier property against ultraviolet rays and rain. However, due to the lipophilic/hydrophobic nature of the surface, it is more prone to fouling by contaminating substances which contain organic components, such as oil, and therefore the stainproof property and especially the rain streaking resistance is inadequate. On the other hand, there are also known types of sheets employing in the resin coating layers synthetic resins which can be shaped without plasticizers, such as fluorine-containing resins, ethylene-vinyl acetate-based resins and other olefin resins, or urethane resins (Patent Document 2: Japanese Unexamined Patent Publication HEI No. 8-259637; Patent Document 3: Japanese Unexamined Patent Publication No. 2000-8276; Patent Document 4: Japanese Unexamined Patent Publication HEI No. 11-323736), but these sheets have the reputation of inadequate stainproof properties and especially rain streaking resistance.

In recent years there have been proposed techniques for enhancing stainproof properties by forming hydrophilic films on the surfaces of sheet materials and the like (Patent Document 5: Japanese Patent No. 3274078; Patent Document 6: Japanese Unexamined Patent Publication No. 2000-238203). In Patent Document 5, the rain streaking resistance is improved by baking an stainproof layer composition comprising PFA resin and/or FEP resin with hydrophilic silicon compound particles, on the surface of a sheet with a PTFE resin as the coating layer, under specific conditions. However, these stainproof layer compositions do not exhibit sufficient surface film strength unless they are baked at high temperatures, and this limits the types of base fabrics and coating synthetic resins that can be used; for example, these stainproof layers cannot be formed on sheets employing vinyl chloride-based resins as the coating synthetic resins. In Patent Document 6, thermal bonding is not possible due to the dense heat-resistant coating prepared from an organosilicate compound formed on the coating resin layer surface, thereby creating an inconvenience in that the surface must be shaved off for bonding.

### DISCLOSURE OF THE INVENTION

It is an object of the present invention to solve the aforementioned problems of the prior art and to provide a stainproof, waterproof sheet having excellent stainproof properties, especially against rain streaking, as well as excellent hot melt bonding properties.

The stainproof, waterproof sheet (1) of the present invention comprises a substrate sheet comprising a base fabric comprising at least one fiber fabric, and a waterproof resin layer formed on at least one surface of the base fabric and containing a synthetic resin, and a stainproof layer formed on said waterproof resin layer of said substrate sheet and containing a synthetic resin and fine amorphous silica particles.

In the stainproof, waterproof sheet (1) of the present invention, the fine amorphous silica particles have a BET specific surface area of 40 to 500 m²/g.

In the stainproof, waterproof sheet (1) of the present invention, the fine amorphous silica particles comprises at least one member selected from fine amorphous silica particles produced by a dry method and a wet precipitation method.

In the stainproof, waterproof sheet (1) of the present invention, the stainproof layer contains the fine amorphous silica particles in a proportion of 5 to 70 mass % with respect to the total mass of the stainproof layer.

In the stainproof, waterproof sheet (1) of the present invention, the synthetic resin contained in the waterproof resin layer comprises at least one member selected from polyolefin resins, chlorinated polyolefin resins, ethylene-vinyl acetate copolymer resins, ethylene-(meth)acrylic acid ester copolymer resins, polyurethane resins, polyester resins, acrylic resins and tetrafluoroethylene-hexafluoropropylene-vinylidene fluoride terpolymer resins.

In the stainproof, waterproof sheet (1) of the present invention, the synthetic resin contained in the stainproof layer comprises at least one member selected from plyolefin resins, ethylene-vinyl acetate copolymer resins, ethylene-(meth)acrylic acid ester copolymer resins, fluorine atom-containing resins, acrylic resins, polyurethane resins and polyester resins.

In the stainproof, waterproof sheet (1) of the present invention, an adhesive layer is further formed between the waterproof resin layer and the stainproof layer.

In the stainproof, waterproof sheet (1) of the present invention, the waterproof resin layer further comprises a flame retardant agent.

In the stainproof, waterproof sheet (1) of the present invention, a front surface waterproof resin layer formed on the front surface of the base fabric further comprises an additive, and an additive migration-preventing layer is formed between the waterproof resin surface layer and said stainproof layer.

In the stainproof, waterproof sheet (1) of the present invention, a back surface waterproof resin layer formed on the back surface of the base fabric further comprises an additive, and an additive migration-preventing layer is formed on the back surface waterproof resin layer.

In the stainproof, waterproof sheet (1) of the present invention, the additive migration-preventing layer comprises at least one synthetic resin selected from polyolefin resins, ethylene-vinyl acetate copolymer resins, ethylene-(meth)acrylic acid ester copolymer resins, fluorine atom-containing resins, acrylic resins, polyurethane resins and polyester resins.

In the stainproof, waterproof sheet (1) of the present invention, the additive contained in said waterproof resin layer is a flame retardant agent.

In the stainproof, waterproof sheet (1) of the present invention, the additive contained in the front surface- and/or back-surface waterproof resin layer contains a condensed phosphoric acid ester flame retardant agent.

The stainproof, waterproof sheet (1) of the present invention, the stainproof layer further contains a flame retardant agent.

The stainproof, waterproof sheet (1) of the present invention, said adhesive layer further contains a flame retardant agent.

The stainproof, waterproof sheet (1) of the present invention, said additive migration-preventing layer further contains a flame retardant agent.

The stainproof, waterproof sheet (1) of the present invention, the heat mass reduction of the substrate sheet measured according to JIS K-6732-1981 is 1.0% or less.

The stainproof, waterproof sheet (1) of the present invention, the stainproof layer is one formed by coating a solution and/or dispersion of the synthetic resin containing fine amorphous silica particles.

A rolled stainproof, waterproof sheet (1) of the present invention is formed by winding up the stainproof, waterproof sheet (1) of the present invention into a roll form.

A stainproof, waterproof sheet (2) of the present invention comprises a substrate sheet comprising a base fabric composed of at least one fiber fabric, and a waterproof resin layer formed on at least one surface of the base fabric, and containing a synthetic resin and a plasticizer and/or softener, and stainproof layer comprising a synthetic resin and fine amorphous silica particles, and formed on the waterproof resin layer of said substrate sheet, wherein the stainproof layer contains the fine amorphous silica particles in a proportion of 10 to 60 mass % based on the total mass of the stainproof layer.

In the stainproof, waterproof sheet (2) of the present invention, the fine amorphous silica particles have a BET specific surface area of 40 to 500 m²/g.

In the stainproof, waterproof sheet (2) of the present invention, the fine amorphous silica particles comprise at least one member of fine amorphous silica particles produced by a dry method and a wet precipitation method.

In the stainproof, waterproof sheet (2) of the present invention, the waterproof resin layer comprises a polyvinyl chloride resin and at least one type of plasticizer selected from phthalic acid ester plasticizers having a molecular weight of 400 or more, aliphatic dibasic acid ester plasticizers having a molecular weight of 420 or more, trimellitic acid ester plasticizers, pyromellitic acid ester plasticizers, dipentaerythritol ester plasticizers, epoxide plasticizers, polyester plasticizers having a molecular weight of 600 or more, ester-type urethane polymer plasticizers, ethylene-vinyl acetate-carbon monoxide terpolymer plasticizers and ethylene-(meth)acrylic acid ester-carbon monoxide terpolymer plasticizers.

In the stainproof, waterproof sheet (2) of the present invention, the synthetic resin contained in said waterproof resin layer is selected from acrylic resins.

In the stainproof, waterproof sheet (2) of the present invention, the synthetic resin contained in the stainproof layer comprises at least one member selected from fluorine atom-containing resins, acrylic resins, polyurethane resins and polyester resins.

In the stainproof, waterproof sheet (2) of the present invention, an adhesive layer is formed between the waterproof resin layer and the stainproof layer.

In the stainproof, waterproof sheet (2) of the present invention, an additive migration-preventing layer is formed between the waterproof resin layer and the stainproof layer.

In the stainproof, waterproof sheet (2) of the present invention, a back surface waterproof resin layer is formed on the back surface of the base fabric, and an additive migration-preventing layer is formed on the back surface waterproof resin layer.

In the stainproof, waterproof sheet (2) of the present invention, the additive migration-preventing layer comprises at least one synthetic resin selected from fluorine atom-containing resins, acrylic resins, polyurethane resins, cyanoethylated ethylene-vinyl alcohol copolymer resins and polyester resins.

In the stainproof, waterproof sheet (2) of the present invention, the waterproof resin layer further comprises a flame retardant agent.

In the stainproof, waterproof sheet (2) of the present invention, the stainproof layer further comprises a flame retardant agent.

In the stainproof, waterproof sheet (2) of the present invention, said adhesive layer further comprises a flame retardant agent.

In the stainproof, waterproof sheet (2) of the present invention, said additive migration-preventing layer further comprises a flame retardant agent.

In the stainproof, waterproof sheet (2) of the present invention, a heat mass reduction of said substrate sheet measured according to JIS K-6732-1981 is 1.0% or less.

In the stainproof, waterproof sheet (2) of the present invention, the stainproof layer is one formed by coating a solution and/or dispersion of the synthetic resin containing the fine amorphous silica particles.

The rolled stainproof, waterproof sheet (2) of the present invention is formed by winding up the stainproof, waterproof sheet (2) of the present invention into a roll form.

### BEST MODE FOR CARRYING OUT THE INVENTION

As a result of diligent research directed toward solving the problems described above, the inventors of the present invention have found that the prevention of rain streaking is drastically improved by forming a stainproof layer comprising a synthetic resin and fine amorphous silica particles as a outermost surface layer of a waterproof sheet satisfying specific conditions, and the present invention has been completed on the basis of this finding.

The stainproof, waterproof sheet (1) according to the invention comprises a substrate sheet comprising a base fabric comprising at least one fiber fabric, and a waterproof resin layer formed on at least one surface of the base fabric, and containing a synthetic resin but no plasticizer, and a stainproof layer formed on the waterproof resin layer of the substrate sheet, and containing a synthetic resin and fine amorphous silica particles.

The stainproof, waterproof sheet (2) according to the invention comprises a substrate sheet comprising at least one fiber fabric, and a waterproof resin layer formed on at least one surface of the base fabric and, containing a synthetic resin and a plasticizer and/or softener, and a stainproof layer formed on the waterproof resin layer of the substrate sheet, and containing a synthetic resin and fine amorphous silica particles, wherein the stainproof layer contains the fine amorphous silica particles in a proportion of 10 to 60 mass % based on the total weight of the stainproof layer.

The fiber fabric to be used for the base fabric of the stainproof and waterproof sheet (1) or (2) of the invention is formed from of at least one type of fiber selected from natural fibers, for example, cotton or hemp; inorganic fibers, for example, glass fibers, carbon fibers or metal fibers; regenerated fibers, for example, viscose rayon or cupra; semi-synthetic fibers, for example, di- and triacetate fibers; and synthetic fibers, for example, polyamide fibers such as nylon 6 or nylon 66, aramid fibers such as Kevlar, polyester fibers (saturated polyester fibers) such as polyethylene terephthalate fibers or polyethylene naphthalate fibers aliphatic polyester fibers, for example, polylactic acid fibers; polyacrylate fibers, aromatic polyether fibers, polyimide fibers, acrylic fibers, vinylon fibers; polyolefin fibers such as polyethylene fibers or polypropylene fibers; and polyvinyl chloride fibers.

The fiber fabric for the base fabric may be formed from yarns in any form, for example, short-fiber spun yarn, continuous filament yarns, split yarns, tape yarns, etc. The base fabric may has a structure of a woven fabric, knitted fabric, nonwoven fabric or composite of two or more thereof. There are also no special restrictions on the weaving and knitting structure of the fiber fabric for the base fabric. For example, it may be a coarse structure fabric formed from yarns including warp and weft yarns respectively arranged in parallel to each other with open gaps therebetween or non-coarse structure fabric (a woven or knitted fabric with substantially no gaps between the yarns). The basis weight of a coarse structure fabric is preferably 30 to 700 g/m², and the percentage of the open gas area of a coarse structure fabric is preferably about 10 to 95% based on the total surface area of the coarse structure fabric. When the fiber fabric for the base fabric is a non-coarse structure fabric, there is no specific limitation to the structure, basis weight and thickness thereof. Usually, the fabric for the base fabric may be selected from woven and knitted fabrics, for example, plain weaves, twill weaves, tubular knitted fabrics, warp knitted fabrics and weft knitted fabrics, in response to the purpose of use. Also, the basis weight is preferably about 50 to 1000 g/m². There is no specific limitation to on the tensile strength of the base fabric. When the stainproof, waterproof sheet is employed as a spreading cover sheet which is fixed under tension, the tensile strength of the base fabric is preferably 392 N/3 cm (40 kgf/3 cm) or more. The fiber base fabrics may, beforehand, be subjected to a water-repellent pre-treatment using water-repellent agents for example, fluorine compounds or silicone compounds, or processed for a softening pre-treatment using softening agents, for example, amino-modified silicone compounds. The base fabric may also be subjected to a flame retardant pre-treatment with a flame retardant agents, for example, phosphoric acid ester compounds.

In the stainproof waterproof sheet (1) of the invention, the waterproof resin layer formed on at least one surface of the base fabric does not contain a plasticizer and/or softener. In the stainproof, waterproof sheet (2) of the invention, the waterproof layer contains the plasticizer and/or softener. As synthetic resins for the waterproof resin layer of the stainproof, waterproof sheet (1) or (2), polyvinyl chloride resins, polyolefin resins, chlorinated polyolefin resins, ethylene-vinyl acetate copolymer resins, ethylene-(meth)acrylic acid ester copolymer resins, ionomer-based resins (salts of ethylene-(meth)acrylic acid copolymers, etc.), polyurethane resins, polyester resins (including aliphatic polyester resins), acrylic resins, fluorine atom-containing resins, styrene copolymer resins (styrene-butadiene-styrene copolymers, styrene-isoprene-styrene copolymers and their hydrogenated products), polyamide resins, polyvinyl alcohol resins, ethylene-vinyl alcohol copolymer resins, silicone resins and other synthetic resins (including thermoplastic elastomers) may be used. These synthetic resins may be used alone or in mixtures of two or more thereof. The waterproof resin layer preferably contains at least one member selected from polyvinyl chloride resins, polyolefin resins, chlorinated polyolefin resins, ethylene-vinyl acetate copolymer resins, ethylene-(meth)acrylic acid ester copolymer resins, polyurethane resins, polyester resins, acrylic resins, and fluorine atom-containing resins. Particularly, the waterproof resin layer more preferably contains at least one member selected from among polyvinyl chloride resins, chlorinated polyolefin resins, ethylene-vinyl acetate copolymer resins, ethylene-(meth)acrylic acid ester copolymer resins, polyurethane resins, polyester resins and tetrafluoroethylene-hexafluoropropylene-vinylidene fluoride terpolymer resins. The waterproof resin layers containing the above-mentioned resins exhibit satisfactory welding processability for the sheet by high-frequency welder working, and are therefore preferred for use in the stainproof, waterproof sheet of the invention.

In the stainproof, waterproof sheet (1) or (2) according to the invention, as polyvinyl chloride resins advantageously usable for the waterproof resin layer at least one member selected from vinyl chloride homopolymer and copolymers of vinyl chloride with other monomers. Monomers that are copolymerizable with vinyl chloride include vinylidene chloride, vinyl acetate, ethylene, acrylonitrile, (meth)acrylic acid esters, etc. There may also be used chlorinated polyvinyl chloride resins obtained by chlorination of polyvinyl chloride resins.

In the stainproof, waterproof sheet (1) or (2) according to the invention, as polyolefin resins suitable for the waterproof resin layer polymerization products of one or more ethylenically unsaturated monomers selected from ethylene and C₃-C₁₈ α-olefins by radical polymerization, ion polymerization, etc., may be employed. The above-mentioned olefin resins may be obtained with various properties depending on the type of catalyst used for polymerization, and for example, they may be produced using catalysts such as Ziegler catalysts or metallocene catalysts. Polyethylene resins and polypropylene-resins are preferred for the present invention. Also, polyolefin elastomers obtained by melt kneading or dynamic vulcanization the above-mentioned resins with ethylene-propylene rubber or ethylene-propylene-diene rubber.

In the stainproof, waterproof sheet (1) or (2) according to the invention, the chlorinated polyolefin resins suitable for the waterproof resin layer include low-chlorinated polyethylene resins, high-chlorinated polyethylene resins, low-chlorinated polypropylene resins and high-chlorinated polypropylene resins. These may be obtained by preparing an aqueous suspension of polyethylene or polypropylene powder, and blowing chlorine gas into the system at a temperature near the crystallization temperature of the starting resin.

In the stainproof, waterproof sheet (1) or (2) according to the invention, the ethylene-vinyl acetate copolymer resins suitable for the waterproof resin layer include copolymer resin with a relatively low content of vinyl acetate, produced by a high-pressure radical polymerization process, or another copolymer resin with a relatively high content of the vinyl acetate, produced by a low-pressure solution polymerization process. The content of the vinyl acetate component in the ethylene-vinyl acetate copolymer resin is preferably 10 to 95 mass %. A high vinyl acetate content is preferred for obtaining a high weldability in high-frequency welder working. The ethylene-vinyl acetate copolymer resins having a content of the vinyl acetate component in the range specified above may be used alone, or in combinations of two or more copolymers different in the content of the vinyl acetate component.

As ethylene-(meth)acrylic acid ester copolymer resins suitable for the waterproof-resin layer of the stainproof waterproof sheet (1) or (2) according to the invention, copolymer resins produced by radical polymerization processes may be used. The copolymer resins can be obtained by polymerization of ethylene monomer with one or more acrylic comonomers selected from methyl acrylate, ethyl acrylate, butyl acrylate, methyl methacrylate, ethyl methacrylate and butyl methacrylate. Also, in the production of the copolymer resins unsaturated carboxylic acids, for example, acrylic acid, methacrylic acid or maleic acid, acid anhydrides, for example, maleic anhydride, epoxy group-containing monomers, for example, glycidyl methacrylate, and other ethylenical comonomers may be employed in addition to the above-mentioned comonomer.

As polyurethane resins suitable for the waterproof resin layer of the stainproof, waterproof sheet (1) or (2) according to the invention, there may be used polyurethane resins obtained by reacting high molecular polyols with polyisocyanates, and optionally a chain extenders. As high molecular polyols for the polyurethane resins, polyester polyols, polyether polyols, polycarbonate polyols, polyester-amide polyols or acrylate polyols, having hydroxyl groups located at both terminals of the molecular chains. Polycarbonate polyols are particularly preferred. The polyisocyanates may include aromatic polyisocyanates, for example, 2,4-tolylene diisocyanate and diphenylmethane diisocyanate, aliphatic polyisocyanates, for example, tetramethylene diisocyanate and 1,6-hexamethylene diisocyanate, and alicyclic polyisocyanates, for example, hydrogenated xylylene diisocyanate and isophorone diisocyanate. The chain extenders include low-molecular polyols, for example, ethylene glycol, propylene glycol, 1,4-butanediol, 1,6-hexanediol and diethylene glycol; aliphatic polyamines, for example, ethylenediamine, propylenediamine, butylenediamine and hexamethylenediamine; alicyclic polyamines, for example, piperazine, 1,4-diaminopiperazine and 1,3-cyclohexylenediamine; aromatic polyamines, for example, diphenylmethanediamine, tolylenediamine and phenylenediamine; and alkanolamines, for example, ethanolamine and propanolamine. Polyurethane resins produced by using, as polyisocyanate components, aliphatic polyisocyanates and cycloaliphatic polyisocyanates exhibit particularly satisfactory weather resistance and are free from yellowing due to ultraviolet ray-exposure.

As polyester resins suitable for the waterproof resin layer of a stainproof, waterproof sheet (1) or (2) according to the invention, there may be used polyester resins obtained by esterification of dicarboxylic acids or their ester-forming derivatives with diols or their ester-forming derivatives and polycondensation of the resultant ester.

As dicarboxylic acids, there may be used one or more selected from, for example, aromatic dicarboxylic acids, for example, terephthalic acid, isophthalic acid and 2,6-naphthalenedicarboxylic acid, or their ester-forming derivatives; aliphatic dicarboxylic acids, for example, adipic acid, succinic acid and sebacic acid, or their ester-forming derivatives; and hydroxycarboxylic acids, for example, p-hydroxybenzoic acid and p-(β-hydroxyethoxy)benzoic acid or their ester-forming derivatives. The diol component may be aliphatic, aromatic or cycloaliphatic diol component, and includes, for example, at least one member selected from among ethylene glycol, diethylene glycol, triethylene glycol, polyethylene glycol, 1,4-butanediol, neopentyl glycol, dipropylene glycol, 1,6-hexanediol, 1,4-cyclohexanediol, xylylene glycol, dimethylolpropionic acid, glycerin, trimethylolpropane and poly(tetramethyleneoxide)glycol.

Also, aliphatic polyester resins obtained by ring-opening polymerization of cyclic esters, for example, β-propiolactone, β-butyrolactone, δ-valerolactone and ε-caprolactone, and lactides.

As acrylic resins suitable for the waterproof resin layer of the stainproof, waterproof sheet (1) or (2) according to the invention, there are preferred resins composed mainly of polymers or copolymers whose major constituent monomers are C₁-C₄ alcohol esters of acrylic acid or methacrylic acid. As major constituent monomers for the acrylic resins, there may be used, specifically, methyl acrylate, methyl methacrylate, ethyl acrylate, ethyl methacrylate, propyl acrylate, propyl methacrylate, butyl acrylate and butyl methacrylate, among which methyl acrylate and methyl methacrylate are particularly preferred. As examples of monomers to be copolymerized with these major constituent monomers there may be mentioned acrylic acid or methacrylic acid and C₁-C₁₂ alcohol esters of acrylic acid or methacrylic acid, as well as monomers such as 2-hydroxyethyl methacrylate, glycidyl methacrylate, N-methylolacrylamide, N,N-dimethylaminoethyl methacrylate, methylvinyl ether, vinylethoxysilane, α-methacryloxypropyltrimethoxysilane, vinyl fluoride, vinylidene fluoride, vinyl chloride, vinylidene chloride, vinyl acetate, styrene, acrylonitrile, methacrylonitrile and butadiene. Copolymers thereof are not limited to random copolymers, and may be graft copolymers if desired. There may also be used acrylic resins containing ethyleneimine residues, alkylenediamine residues, etc.

The waterproof resin layer of the stainproof, waterproof sheet (1) or (2) according to the invention, comprising of any of above-mentioned synthetic resins, may also contain, in admixture, one or more additives selected from stabilizers, antioxidants, ultraviolet absorbers, photostabilizers, lubricants, fillers, coloring agents, antifungal agents, antibacterial agents, antistatic agents, curing agents, flame retardants, etc. The additives may be any additives which are publicly known in the relevant technical field, with no particular restrictions. A flame retardant is preferably added to the stainproof waterproof sheet (1) or (2) of the invention in order to satisfy the flameproof resistance required for sheet materials for tents (standard JIS L-1091 or standard JIS A-1322). However, the waterproof resin layer of the stainproof, waterproof sheet (1) contains no plasticizer or softener, whereas the waterproof resin layer of the stainproof waterproof sheet (2) contains a plasticizer and/or softener. Examples of plasticizers to be used in the waterproof resin layer of the stainproof, waterproof sheet (2) include plasticizers comprising mainly of phthalate esters, adipate esters, fumarate esters, maleate esters, azelaate esters, sebacate esters, citrate esters, phosphorate esters, polyesters, etc.

Examples of softeners include softeners comprising mainly of paraffins, petroleum fractions, aromatic hydrocarbons and vegetable oils. Examples of stabilizers include stabilizers comprising organic tin compounds phosphites, metal soaps, etc.

Examples of antioxidants for the waterproof resin layer include antioxidants comprising hindered phenol, amine, phosphite, and organic sulfur compounds, etc.

Examples of ultraviolet ray-absorbers include ultraviolet ray-absorbers comprising of benzophenone, benzotriazole, and salicylic acid compounds, etc.

Examples of photostabilizers include photostabilizers comprising hindered amine, benzoate compounds, etc.

Examples of lubricants include lubricants comprising paraffins, fatty acids, esters, amides, phosphoric acid esters, metal soaps, etc.

Examples of fillers include inorganic fillers, for example, calcium carbonate, calcium silicate, barium sulfate, zinc oxide, alumina, silica, kaolin clay, talc, diatomaceous earth, mica, glass beads, etc., and organic fillers, for example, styrene beads, acryl beads, cellulose beads, nylon beads, urea resin beads, collagen powder, etc.

Examples of coloring agents include inorganic coloring agents, for example, titanium oxide, iron oxide, chromic acid, cadmium, compound oxides, pearl, mica, aluminum, carbon black pigments, etc., and organic coloring agents comprising azo, phthalocyanine, quinacridone, isoindolinone, perylene, perynone, anthraquinone, quinopthalone, pyrrole compounds, etc.

Examples of antifungal agents include antifungal agents comprising organic nitrogen, organic nitrogen-sulfur, halogenated organic nitrogen, organic nitrogen-sulfur halogens, halogenated organic acid esters, benzimidazoles, pyrithione, quaternary ammonium compounds, etc.

Examples of antibacterial agents include antibacterial agents comprising organic acid metal salts, silver, zinc, copper compounds, etc.

Examples of antistatic agents include antistatic agents comprising surfactants, cationic polymers, anionic polymers, silver oxide-antimony oxide compounds, etc.

Examples of curing agents include curing agents comprising isocyanates, oxazoline, carbodiimide, aziridine, melamine and epoxy compounds, and coupling agents, etc.

As flame retardants for the waterproof resin layer, for example, red phosphorus, polyammonium phosphate, phosphoric acid ester flame retardants, chlorine atom-containing flame retardants, bromine atom-containing flame retardants, triazine derivative compounds, cyanamide derivative compounds, urea compounds, silicone resins and inorganic flame retardants are usable for the present invention.

Red phosphorus, when used, may be stabilized by resin coating the surface with a melamine-based resin etc., or subjected to whitening treatment with titanium oxide, etc.

Polyammonium phosphate is represented by (NH₄PO₃)ₙ, wherein n represents a polymerization degree of 30-1200. Particularly, polyammonium phosphate particles surface coated with a melamine resin, etc. to thereby enhance the water resistance are preferred.

As phosphoric acid ester flame retardants, halogen atom-containing phosphate ester compounds, for example, trischloroethyl phosphate, trisdichloropropyl phosphate, tris(2,3-dibromopropyl) phosphate, tris(dibromophenyl) phosphate and tris(tribromoneopentyl phosphate); linear alkyl phosphate ester compounds, for example, trimethyl phosphate, triethyl phosphate, tripropyl phosphate, tributyl phosphate, tripentyl phosphate, trihexyl phosphate, dimethylethyl phosphate and methyldibutyl phosphate; aromatic phosphate ester compounds, for example, triphenyl phosphate, tricresyl phosphate, diphenyloctyl phosphate, p-benzylphenyl phosphate and hydroxyphenyldiphenyl phosphate; and condensed phosphate ester compounds, for example, 1,3-phenylenebis(diphenyl phosphate), 1,3-phenylenebis(dixylenyl phosphate) and bisphenol A bis(diphenyl phosphate), may be employed for the present invention.

As chlorine atom-containing flame retardants, chlorinated paraffin, chlorinated polyethylene and bis(hexachlorocyclopentadieno)cyclooctane may be used for the present invention.

As bromine atom-containing flame retardants, decabromodiphenyl, pentabromoethylbenzene, decabromodiphenyl oxide, pentabromocyclohexane, bistribromophenoxyethane, tribromophenol, ethylenebispentabromodiphenyl, hexabromobenzene, hexabromocyclododecane, octabromonaphthalene, tetrabromobisphenol A, tetrabromobisphenol S, ethylenebistribromophenyl ether, tetradecabromodiphenoxybenzene, 1,2-bis(tribromophenoxy)ethane and tris(2,4,6-tribromophenoxy)isocyanurate may be used for the present invention.

As triazine derivative-based compounds, 2-methyl-4,6-diamino-triazine, melamine, melamine sulfate, melamine phosphate, polymelamine phosphate, methylol melamine, trimethyl cyanurate, triethyl cyanurate, ammeline, ammelide, guanamine, benzoguanamine, etc., are usable for the present invention. Particularly, melamine cyanurate and melamine isocyanurate obtained by reaction of melamine with cyanuric acid or isocyanuric acid, are preferably employed. (Cyanuric acid exists in two tautomeric isomer forms; chemically, the enolic form is referred to as cyanuric acid and the keto form is referred to as isocyanuric acid.)

As cyanamide derivative compounds, dicyandiamide, dicyandiamidine, guanidine, guanidine sulfamate, guanidine phosphate and diguanide are usable for the present invention.

As urea-based compounds, urea, dimethylolurea, diacetylurea, trimethylurea, N-benzoylurea and guanylurea phosphate are usable for the present invention.

As silicone resins, powdered silicone resins can be used for the present invention.

As inorganic flame retardants, inorganic hydrates containing water of crystallization, for example, magnesium hydroxide, aluminum hydroxide, sodium tetraborate, magnesium phosphate, sodium diphosphate and zinc phosphate; tin compounds, for example, metastannic acid, zinc stannate and zinc hydroxystannate; boric acid compounds, for example, boric acid, zinc borate and aluminum borate; and antimony trioxide, etc., can be used for the present invention.

In the stainproof, waterproof sheet (1) or (2) according to the present invention, when a flame retardant is added to the waterproof resin layer this flame retardant is preferably selected from those that are in the state of a solid under the conditions under which the stainproof, waterproof sheet (1) or (2) of the present invention is used, or in other words, that has a melting temperature of 80° C. or more. This is because in the case where the sheet is used outdoors, particularly during periods with abundant sunlight, for example, summertime, the temperature of the sheet surface may exceed 70° C. under the rays of the sun. Consequently, if the melting temperature of the flame retardant for the waterproof resin layer is below 80° C., an increase in the sheet surface temperature above the melting temperature of the flame retardant for the stainproof layer due to the rays of the sun during outdoor use, causes the flame retardant to melt and the melted flame retardant to migrate into the surface of the stainproof layer, and thereby the stainproof property is decreased. The melting temperature is preferably 100° C. or higher, and more preferably 130° C. or higher. Such flame retardants may be selected, as desired, from flame retardant compounds which can be used for waterproof resin layer, have a melting temperature of 80° C. or higher. The use of condensed phosphate ester flame retardants is particularly preferred. Condensed phosphate ester flame retardants exhibit a high flame retardant effect and are suitable for non-halogen atom-containing resins.

In the stainproof, waterproof sheet (2) according to the invention, when a polyvinyl chloride resin is used for the waterproof resin layer, it is preferred to use, as a main plasticizer, at least one plasticizer selected from, liquid plasticizers selected from phthalic acid ester plasticizers having molecular weight of 400 or more, aliphatic dibasic acid ester plasticizers having a molecular weight of 420 or more, trimellitic acid ester plasticizers, pyromellitic acid ester plasticizers, epoxide plasticizers, dipentaerythritol ester plasticizers and polyester plasticizers having a molecular weight of 600 or more; and polymeric plasticizers selected from ester type urethane polymer plasticizers, ethylene-vinyl acetate-carbon monoxide terpolymer plasticizers and ethylene-(meth)acrylic acid ester-carbon monoxide terpolymer plasticizers. The above-mentioned plasticizers are suitable for the present invention, because they have much lower volatility, and also lower tendency to migration, than those of dibutyl phthalate, di-2-ethylhexyl phthalate, di-n-octyl phthalate or dioctyl adipate, which are conventionally used as plasticizers for polyvinyl chloride resins. Polyester plasticizers and the aforementioned polymeric plasticizers are particularly preferred for the present invention.

As phthalic acid ester plasticizers having a molecular weight of 400 or more, for example, diisononyl phthalate, diisodecyl phthalate, diundecyl phthalate, ditridecyl phthalate, butylbenzyl phthalate, etc., are preferably used.

As aliphatic dibasic acid ester plasticizers having a molecular weight of 420 or more, diisodecyl adipate, dibutoxyethyl adipate, di-2-ethylhexyl sebacate, di-2-ethylhexyl dodecanoate, etc. are preferably used. Aliphatic dibasic acid ester plasticizers are slightly more volatile compared with phthalic acid ester plasticizers having an equivalent molecular weight, and therefore, the polymeric plasticizers having a high molecular weight are preferably employed.

As trimellitic acid ester plasticizers and pyromellitic acid ester plasticizers, those obtained by condensation reaction of trimellitic acid with monohydric alcohols and of pyromellitic acid with monohydric alcohols are preferably employed. As trimellitic acid ester plasticizers, tris-2-ethylhexyl trimellitate, trisisodecyl trimellitate, etc. are preferably employed, and as pyromellitic acid ester plasticizers, tetra-2-ethylhexyl pyromellitate, etc. is preferably used.

As epoxide plasticizers, epoxidized soybean oil, epoxidized linseed oil, etc. are preferably employed.

As polyester plasticizers, polyesters produced by condensation-polymerization of a dicarboxylic acid, for example, adipic acid, azelaic acid, sebacic acid or phthalic acid, with a diol, for example, ethylene glycol, 1,2-butanediol or 1,6-hexanediol, are preferably employed for the present invention. The molecular weight of the polyester plasticizer is preferably 600 or more, more preferably 1000 or more, still more preferably 1500 to 4000. If the molecular weight is too small, the volatility and tendency to migrate of the resultant plasticizer undesirably increase to too high. Conversely, if the molecular weight is too large, the melt viscosity increases to high during kneading the plasticizer with the polyvinyl chloride resin, thereby impairing the workability.

As ester-type urethane polymer plasticizers, reaction products of polyester polyols with diisocyanates can be employed for the present invention. The urethane polymers include ether type urethane polymers and carbonate type urethane polymers, in addition to ester type urethane polymers, but ester type urethane polymers are most preferred, because of their high plasticizing efficiency for polyvinyl chloride resins. Particularly, the ester type urethane polymers produced by using, as the diisocyanates, aliphatic diisocyanates or cycloaliphatic diisocyanates, for example, tetramethylene diisocyanate, 1,6-hexamethylene diisocyanate, isophorone diisocyanate or hydrogenated xylylene diisocyanate (which compounds may be hydrogenated), are preferred, because they are not only not yellowed under ultraviolet ray exposure, but also exhibit higher plasticizing efficiency for polyvinyl chloride resins, than when aromatic diisocyanates are used.

The polymeric plasticizers selected from ester type urethane polymer plasticizers, ethylene-vinyl acetate-carbon monoxide terpolymer plasticizers and ethylene-(meth)acrylic acid ester-carbon monoxide terpolymer plasticizers have markedly higher molecular weight than conventional plasticizers, and they are therefore non-volatile and non-extractable, such that their molded products therefore exhibit excellent durability.

In the stainproof waterproof sheet (2) of the present invention, when an acrylic resin is used for the waterproof resin layer, a plasticizer may be added to the acrylic resin for the purpose of enhancing the flexibility of the waterproof layer. Examples of this type of plasticizers include dibutyl phthalate, dioctyl phthalate, butylbenzyl phthalate, myristylbenzyl phthalate, tributyl acetylcitrate, diphenyldecyl phosphate, tricresyl phosphate, cresyldiphenyl phosphate, etc. Such plasticizers have a high polarity and a high compatibility with acrylic resins, such that the plasticizer does not readily migrate to the surface of the waterproof layer.

In the stainproof, waterproof sheet (1) or (2) of the present invention, when the synthetic resin containing an additive, or a plasticizer and/or softener, is used in the waterproof resin layer of the substrate sheet, the heat mass reduction of the substrate sheet is preferably no greater than 1.0% as measured according to JIS K-6732-1981. If the heat mass reduction of the substrate sheet exceeds 1.0%, it cannot maintain a satisfactory stainproof property for prolonged periods. While the reason for the decrease in the stainproof property with increase in the heat mass reduction to more than 1.0% has not yet fully clarified, it is conjectured that with outdoor use of the sheet, the effects of the rays of the sun during daytime causes the temperature of the waterproof resin layer to increase, and thereby the additives contained therein to be gradually vaporized and thus the stainproof property of the stainproof layer to decrease. It is therefore preferred for the plasticizer and softener used with the synthetic resin to have low volatility, and in cases where a high volatility is unavoidable, the amounts thereof must be as low as necessary to achieve a heat mass reduction of no greater than 1.0%. It is even more preferred for the heat mass reduction to be no greater than 0.50%.

The waterproof resin layer of the stainproof, waterproof sheet (1) or (2) of the present invention may have any desired thickness as appropriate for the basis weight of the base fabric and the intended use, but it is preferably adjusted to a sufficient thickness, for example, 0.01 to 2.0 mm, more preferably 0.05 to 1.5 mm, so that the resulting sheet has the desired waterproofing property and mechanical strength. Also, the waterproof resin layer on the base fabric may be constituted from a single layer of the same resin or 2 or more layers formed from different resins from each other, and the front and back surfaces of the base fabric may be coated with resins different from each other.

The waterproof resin layer of the stainproof, waterproof sheet (1) or (2) of the present invention may be formed on the base fabric by a publicly known method such as topping, calendering, coating, or dipping method, etc., using a film, solution, emulsion, paste sol, etc. containing the aforementioned synthetic resin or the synthetic resin and plasticizer and/or softener.

The fine amorphous silica particles in the stainproof layer of the stainproof, waterproof sheet (1) or (2) of the present invention may comprise one or more types of fine amorphous silica particles produced by a production process such as a dry method, wet method, aerogel method, etc. They may also be fine amorphous silica (molten silica) particles obtained by completely melting crystalline silica (natural silica) at high temperature. In the dry method, fine anhydrous silica particles are produced at a high temperature of 1000° C. or higher. The dry method is further classified to a combustion method and an arc method. In the combustion method, silica particles are obtained by mixing gasified silicon tetrachloride with hydrogen and burning the mixture in air at 1600 to 2000° C. or higher. In the arc method, silica particles are obtained by heat reduction of silica sand with coke in an arc furnace to oxidize the generated SiO vapor in air. In the wet method, sodium silicate, a mineral acid and a salt are reacted with each other in aqueous solution, and wet method is classified to a direct method in which sodium silicate is decomposed with a mineral acid, and an indirect method in which sodium silicate is reacted with an alkali earth metal salt to form a silicate, which is then decomposed with a mineral acid or carbon dioxide gas. The direct method is further classified to precipitation method (wet precipitation method) in which sodium silicate and a mineral acid are reacted with each other under an alkali side condition to precipitate silica, and a gel method (wet gel method) in which they are reacted with each other under a acid side condition to form a silica sol which is then gelled. The aerogel method comprises reacting sodium silicate with a mineral acid, to form a silica gel; replacing the water in the gel with an organic solvent such as an alcohol, to form an organogel; then heating the organogel in an autoclave to remove the solvent and obtain a silica aerogel. The fine amorphous silica particles in the stainproof, waterproof sheet (1) or (2) of the present invention preferably in the form of particles having a mean particle size of 30 μm or less, and more preferably 20 μm or less. If the mean particle size of the fine amorphous silica particles exceeds 30 μm, various inconveniences may occur such as a reduced coating strength of the stainproof layer, or an enhanced tendency toward precipitation of the fine amorphous silica particles when the stainproof layer is formed from a liquid.

Addition of fine amorphous silica particles into the stainproof layer in a manner such that the surfaces of the fine amorphous silica particle are exposed on the stainproof layer surface causes the hydrophilicity of the stainproof layer to be enhanced and the stainproof property and the resistance to rain streaking stain of the waterproof sheet to be improved. The fine silica particles are widely used as delustering agents or anti-blocking agents for paints, but the formulation of the present invention is different from the formulations of the above-mentioned agents. Thus, the fine silica particles used for the stainproof, waterproof sheet (1) or (2) of the present invention preferably have a BET specific surface area of 40 to 500 m²/g, more preferably 40 to 400 m²/g. The fine Silica particles having a BET specific surface area of less than 40 m²/g or the fine silica particles having a BET specific surface area of more than 500 m²/g exhibit a low effect on imparting hydrophilicity to the stainproof layer. In the stainproof, waterproof sheet (1) or (2) of the present invention, fine silica particles are particularly preferably selected from fine silica particles produced by a dry method or wet precipitation method. Generally, the fine amorphous silica particles, are constituted from secondary particles which are three-dimensional aggregates of primary particles. The particles obtained by the above-mentioned production methods are characterized by low constitutive property of the silica aggregate particles and easy break-up of the aggregates by external force, for example, shearing force. It is conjectured that this characteristic feature of the silica particles results in satisfactory dispersion of the fine amorphous silica particles in the stainproof layer, to allow the resultant stainproof layer to exhibit an excellent stainproof property. When the above-mentioned fine amorphous silica particles are used, the resultant stainproof layer exhibits a satisfactory stainproof property even when the amount of the fine amorphous silica particles is small, thereby allowing the influence on the coating properties of the stainproof layer to be minimized. The content of the fine amorphous silica particles contained in the stainproof layer of the stainproof, waterproof sheet (1) of the invention is preferably 5 to 70 mass %, more preferably 10 to 50 wt %, based on the total mass of the stainproof layer. At less than 5 mass %, a sufficient stainproof property cannot be obtained, while at more than 70 mass %, the coating strength of the stainproof layer is significantly reduced, rendering the stainproof layer to be susceptible to damage or to flaking away when the sheet is bent.

The content of the fine amorphous silica particles in the stainproof, waterproof sheet (2) of the present invention is preferably 10 to 60 mass %, more preferably 15 to 40 mass %, based on the total mass of the stainproof layer. When the stainproof, waterproof sheet (2) according to the present invention is used for long periods of time outdoors, the plasticizer and/or softener in the waterproof resin layer tends to migrate to the surface of the sheet with a lapse of time, thereby lowering the hydrophilicity of the stainproof layer, and it is therefore necessary to increase the amount of the fine amorphous silica particles contained in the stainproof layer as compared to formation of the stainproof layer formed on the waterproof resin layer containing no plasticizer and/or softener. In the case of the stainproof, waterproof sheet (2) of the present invention, however, the upper limit for the content of the fine amorphous silica particle must be 60 mass %. This is because when the fine amorphous silica particle content exceeds 60 wt %, in initial stage of the use, the hydrophilicity of the stainproof layer is improved and thus the stainproof property of the stainproof layer is enhanced. However, the migration of the plasticizer and/or softener contained in the waterproof resin layer to the surface of the sheet becomes easier than the case of a smaller amorphous silica fine particle content, and thus, the long-term stainproof property is instead reduced.

As synthetic resins for the stainproof layer of the stainproof, waterproof sheet (1) or (2) according to the present invention, at least one member selected from, for example, polyvinyl chloride resins, polyolefin resins, ionomer resins, ethylene-vinyl acetate copolymer resins, ethylene-vinyl alcohol copolymer resins, polyvinyl alcohol resins, polyvinylbutyral resins, cellulose ester resins, cellulose ethers, polyurethane resins, polyester resins (including aliphatic polyester resins), acrylic resins, polycarbonate resins, polyamide resins, silicone resins, fluorine atom-containing resins, etc. can be used for the present invention. Particularly one or more members selected from fluorine atom-containing resins, acrylic resins, polyurethane resins and polyester resins are more preferably used.

As polyolefin resins for the stainproof layer of the stainproof, waterproof sheet (1) or (2) according to the present invention, at least one ethylenically unsaturated monomers selected from among ethylene and C₃-C₁₈ α-olefins, produced by radical polymerization, ion polymerization, etc., are preferably used. The properties of the polyolefin resins is varied in response to the type of the polymerization catalyst, and for example, they may be produced using catalysts, for example, Ziegler catalysts or metallocene catalysts. Polyethylene resins and polypropylene resins are preferred for the present invention. There may also be used polyolefin elastomers produced by melt kneading the polyolefin resin with an ethylene-propylene rubber or ethylene-propylene-diene rubber or dynamic vulcanization the polyolefin resin with the rubber.

As ethylene-vinyl acetate copolymer resins for the stainproof layer of the stainproof waterproof sheet (1) or (2) according to the present invention, copolymer resins having a relatively low vinyl acetate content, and produced by a high-pressure radical polymerization process, or another copolymer resins having a relatively high vinyl acetate content, and produced by a low-pressure solution polymerization process, can be used for the present invention. The vinyl acetate content of the ethylene-vinyl acetate copolymer resins is preferably 10 to 95 mass %. A high vinyl acetate content copolymers are preferred for high weldability in high-frequency welder working. The ethylene-vinyl acetate copolymer resins having vinyl acetate contents in the range specified above may be used alone, or in combinations of two or more copolymers different in vinyl acetate contents from each other.

As ethylene-(meth)acrylic acid ester copolymer resins suitable for the stainproof layer of the stainproof, waterproof sheet (1) or (2) according to the present invention, copolymer resins produced by radical polymerization processes, can be employed. There copolymers can be obtained by polymerization of ethylene monomer with one or more of acrylic comonomers selected from methyl acrylate, ethyl acrylate, butyl acrylate, methyl methacrylate, ethyl methacrylate and butyl methacrylate. There may also be used therewith unsaturated carboxylic acids, for example, acrylic acid, methacrylic acid or maleic acid; acid anhydrides, for example, maleic anhydride; epoxy group-containing monomers, for example, glycidyl methacrylate; and other ethylenically unsaturated comonomers.

Examples of fluorine atom-containing resins which may be used for the stainproof layer of the stainproof, waterproof sheet (1) or (2) according to the present invention comprises one or more members selected from tetrafluoroethylene polymer, tetrafluoroethylene-perfluoroolefin copolymers (for example, tetrafluoroethlyene-hexafluoropropylene copolymer), tetrafluoroethylene-perfluoroalkylvinylether copolymer, tetrafluoroethylene-perfluoroalkylvinylethylene copolymer, chlorotrifluoroethylene polymer, vinylidene fluoride-based polymers, chlorotrifluoroethylene-ethylene copolymer, etc. In particular, as vinylidene fluoride polymers, copolymers obtained by copolymerization of vinylidene fluoride with one or more copolymerizable monomers, selected from for example, tetrafluoroethylene, trifluoroethylene, chlorotrifluoroethylene, fluoroethylene, (meth)acrylic acid esters, vinyl ethers, vinyl esters, etc. can be used. These copolymers are not limited to random copolymers, and may be graft copolymers if desired. There may also be used fluorine-modified resins obtained by modification of synthetic resins such as acrylic resins or polyurethane resins, with fluorine.

The acrylic resins usable for the stainproof layer of the stainproof, waterproof sheet (1) or (2) of the present invention are preferably selected from polymers or copolymers whose major constituent monomers are C₁-C₄ alcohol esters of acrylic acid or methacrylic acid. Specifically, the major constituent monomers for the acrylic resins, preferably include methyl acrylate, methyl methacrylate, ethyl acrylate, ethyl methacrylate, propyl acrylate, propyl methacrylate, butyl acrylate and butyl methacrylate, more preferably methyl acrylate and methyl methacrylate. The monomers to be copolymerized with these major constituent monomers preferably include acrylic acid, methacrylic acid, C₁-C₁₂ alcohol esters of acrylic acid or methacrylic acid, as well as monomers such as 2-hydroxyethyl methacrylate, glycidyl methacrylate, N-methylolacrylamide, N,N-dimethylaminoethyl methacrylate, methylvinyl ether, vinylethoxysilane, α-methacryloxypropyltrimethoxysilane, vinyl fluoride, vinylidene fluoride, vinyl chloride, vinylidene chloride, vinyl acetate, styrene, acrylonitrile, methacrylonitrile and butadiene. The above-mentioned copolymers are not limited to random copolymers, and may be graft copolymers if desired. For example, there may be used polymers obtained by graft polymerization after addition of vinylidene fluoride to a methyl methacrylate polymer. There may also be usable acrylic resins containing ethyleneimine residues, alkylenediamine residues.

The polyurethane-based resins usable for the stainproof layer of the stainproof, waterproof sheet (1) or (2) of the present invention, preferably include polyurethane resins obtained by reacting high molecular polyols with polyisocyanates, and optionally with chain extenders. The high molecular polyols for the polyurethane resins are preferably selected from polyester polyols, polyether polyols, polycarbonate polyols, polyesteramidepolyols or acrylate polyols, having hydroxyl groups at both terminals of the molecular chains thereof. For the purpose of conferring hydrophilicity. Diethylene glycol, triethylene glycol, polyethylene glycol, etc. may be used together with the aforementioned polyols. The polyisocyanates for the polyurethane resins are preferably selected from aromatic polyisocyanates, for example, 2,4-tolylene diisocyanate and diphenylmethane diisocyanate; aliphatic polyisocyanates, for example, tetramethylene diisocyanate and 1,6-hexamethylene diisocyanate; and cycloaliphatic polyisocyanates, for example, hydrogenated xylylene diisocyanate and isophorone diisocyanate. The chain extenders for the polyurethane resins are preferably selected from low-molecular polyols, for example, ethylene glycol, propylene glycol, 1,4-butanediol, 1,6-hexanediol and diethylene glycol; aliphatic polyamines, for example, ethylenediamine, propylenediamine, butylenediamine and hexamethylenediamine; cycloaliphatic polyamines, for example, piperazine, 1,4-diaminopiperazine and 1,3-cyclohexylenediamine; aromatic polyamines, for example, diphenylmethanediamine, tolylenediamine and phenylenediamine; and alkanolamines, for example, ethanolamine and propanolamine. Polyurethane resins comprising, as polyisocyanate components, aliphatic polyisocyanates and cycloaliphatic polyisocyanates exhibit particularly satisfactory weather resistance without yellowing due to ultraviolet ray-exposure.

The polyester resins suitable for the stainproof layer of the stainproof, waterproof sheet (1) or (2) according to the present invention, are preferably resins obtained by esterification of dicarboxylic acids or their ester-forming derivatives with diols or their ester-forming derivatives and polycondensation of the ester compounds.

The dicarboxylic acids include at least one member selected from, for example, aromatic dicarboxylic acids, for example, terephthalic acid, isophthalic acid and 2,6-naphthalenedicarboxylic acid; ester-forming derivatives of the above-mentioned aromatic dicarboxylic acids, aliphatic dicarboxylic acids, for example, adipic acid, succinic acid and sebacic acid, and ester-forming derivatives of the above-mentioned aliphatic dicarboxylic acids; hydroxycarboxylic acids, for example, p-hydroxybenzoic acid and p-(β-hydroxyethoxy)benzoic acid and ester-forming derivatives of the above-mentioned hydroxycarboxylic acids. The diol component may be selected from aliphatic, aromatic or alicyclic dioles, for example, ethylene glycol, diethylene glycol, triethylene glycol, polyethylene glycol, 1,4-butanediol, neopentyl glycol, dipropylene glycol, 1,6-hexanediol, 1,4-cyclohexanediol, xylylene glycol, dimethylolpropionic acid, glycerin, trimethylolpropane and poly(tetramethyleneoxide)glycol.

There may also be used aliphatic polyester resins obtained by ring-opening polymerization of cyclic esters or lactides, for example, β-propiolactone, β-butyrolactone, δ-valerolactone and ε-caprolactone, for the present invention.

The synthetic resins for the stainproof layer of the stainproof, waterproof sheet of the present invention is preferably selected those that exhibit adequate surface coating strength without using a curing agent, in order to avoid impairing the weldability between sheets. Particularly, preferred synthetic resins are polycarbonate polyurethane resins, acrylic resins and polyester resins. The above-mentioned synthetic resins for the stainproof layer exhibit adequate surface coating strength even without applying a high-temperature curring as required for fluorine atom-containing resins, and are therefore suitable for use in the stainproof, waterproof sheet (1) or (2) according to the present invention.

The stainproof layer optionally contains, in addition to the synthetic resin and the fine amorphous silica particles, one or more additives selected from ultraviolet ray-absorbers, photostabilizers, antifungal agents, antibacterial agents, fillers, coloring agents, curing agents, flame retardants, etc. Particularly, when an ultraviolet ray-absorber is used, the agent preferably comprises at least one copolymer comprising at least one ultraviolet absorbing monomers, for example, benzotriazole compounds and benzophenone compounds. The fillers include inorganic fillers and organic fillers. The examples of inorganic-based fillers include precipitated calcium carbonate, ground calcium carbonate, kaolin, talc, calcium sulfate, barium sulfate, titanium oxide, zinc oxide, zinc sulfate, zinc carbonate, satin white, aluminum silicate, diatomaceous earth, calcium silicate, aluminum hydroxide, silica, alumina, magnesium oxide and magnesium hydroxide, and the examples of organic fillers include styrene resin beads, acrylic resin beads, chitosan polymer beads, cellulose beads, nylon resin beads and urea resin beads. These fillers may be used alone or in combinations of two or more thereof. The coloring agents include organic coloring agents and inorganic coloring agents. The curing agents may be selected from isocyanate, oxazoline, carbodiimide, aziridine, melamine, epoxy curing agents and coupling agents, etc.

When a curing agent is used, however, the amount of the curing agent must be in the range in which the weldability of the resultant cured stainproof layer is not degraded. Usually, the amount of the curing agent is preferably no greater than 5 parts by mass per 100 parts by mass of the synthetic resin in the stainproof layer. When the amount of the curing agent is greater than 5 parts by mass, difficulties may arise for welding by high-frequency welding method or hot-air welding method.

When a flame retardant is added to the stainproof layer of the stainproof, waterproof sheet (1) or (2) according to the present invention, the flame retardant is preferably selected from those that are in the state of a solid under the conditions under which the stainproof, waterproof sheet (1) or (2) of the present invention is used, namely from those having a melting temperature of 80° C. or more. This is because when the sheet is used outdoors, particularly during periods with abundant sunlight such as in summertime, the temperature of the sheet surface often exceeds 70° C. under the rays of the sun. Consequently, if the melting temperature of the flame retardant for the stainproof layer is below 80° C., and when the stainproof layer is exposed to outdoors and the temperature of the sheet surface increases above the melting temperature of the flame retardant of the stainproof layer due to the sun's rays during the outdoor use, the flame retardant is melted and migrates into the surface of the sheet, and thereby the stainproof property of the stainproof layer decreases. The melting temperature of the flame retardant is preferably 100° C. or more, more preferably 130° C. or more. The flame detardents for the stainproof layer comprises at least one member selected from, for example, flame retardant compounds usable for the waterproof resin layer, having melting temperature of 80° C. or more. Preferably, from the flame retardants are selected from inorganic flame retardants having a melting temperature of 80° C. or more from the standpoint of stainproof property and weather resistance of the resultant sheet.

The stainproof layer of the stainproof, waterproof sheet (1) or (2) of the present invention can be formed from a film, solution, emulsion, etc. containing the synthetic resin and fine amorphous silica particles, by a publicly known method such as a topping, laminating, and coating methods. In particular, the stainproof layer is preferably formed by coating a solution and/or dispersion of the synthetic resin mixed with fine amorphous silica particles. A satisfactory stainproof property can be obtained even with a low mixing proportion of the fine amorphous silica particles in the stainproof layer.

As an optional pretreatment prior to the formation of the stainproof layer on the waterproof resin layer, the surface of the waterproof resin layer is subjected to corona discharge treatment or plasma treatment, and then the stainproof layer is formed. When a stainproof layer formed in a film is used, the stainproof film is subjected to a corona discharge treatment or plasma treatment, and the treated surface of the stainproof film is adhered to the waterproof resin layer. The thickness of the stainproof layer is preferably 0.3 to 50 μm, more preferably 1 to 30 μm. When the thickness is less than 0.3 μm, the resultant stainproof property may be insufficient, while the thickness of more than 30 μm causes the resultant stainproof effect to be saturated.

An adhesive layer is optionally formed between the stainproof layer and waterproof resin layer of an stainproof, waterproof sheet (1) or (2) according to the present invention. Formation of the adhesive layer can enhance the adhesion of the stainproof layer to the waterproof resin layer. The adhesive layer preferably contains one or more synthetic resins selected from synthetic resins, for example, polyvinyl chloride resins, acrylic resins, polyurethane resins, polyethylene resins, ionomer resins, epoxide resins, melamine resins, polypropylene resins, polyamide resins, polyester resins, ethylene-vinyl alcohol copolymer resins, ethylene-vinyl acetate copolymer resins, polyvinyl alcohol resins, polyvinylbutyral resins, silicone resins, fluorine atom-containing resins, fluorine-modified resins, etc. The stainproof layer may formed on the waterproof layer through an adhesive composed mainly of natural rubber, synthetic rubbers, regenerated rubbers, acrylic, silicone, etc. The adhesive layer optionally further contain, one or more additives selected from ultraviolet ray-absorbers, photostabilizers, antifungal agents, antibacterial agents, fillers, coloring agents, curing agents, flame retardants, etc.

Where a flame retardant is contained in the adhesive layer of the stainproof, waterproof sheet (1) or (2) according to the present invention, the flame retardant is preferably selected from those are in the state of a solid under the conditions under which the stainproof, waterproof sheet (1) or (2) of the present invention is used, or in other words, having a melting temperature of 80° C. or more. The melting temperature is more preferably 100° C. or more, still more preferably 130° C. or more. The flame retardants for the adhesive layer preferably comprises at least one member selected from flame retardant compounds that can be used for the waterproof resin layer, and have a melting temperature of 80° C. or more. From the standpoint of stainproof property and weather resistance, it is preferred that the flame retardants are selected from inorganic flame retardants with melting temperature of 80° C. or more.

The adhesive layer of the stainproof, waterproof sheet (1) or (2) of the present invention may be formed on the waterproof resin layer by a publicly known method, for example, topping, laminating and coating methods, using a film, solution, emulsion, etc. containing the synthetic resin or adhesive for the adhesive layer. There are no particular limitation on the thickness of the adhesive layer, but it is preferably 0.3 to 200 μm. An adhesive layer having a thickness of less than 0.3 μm may result in difficulties for production, for example, a special machine for processing is required. Also a thickness of more than 200 μm may cause problems such the resulting stainproof, waterproof sheet exhibits a hard touch.

When the waterproof resin layer of the base sheet of the stainproof, waterproof sheet (1) according to the present invention contains additives (especially a flame retardant having a melting point of below 80° C.), or in the case of the stainproof, waterproof sheet (2), an additive migration-preventing layer is preferably formed between the waterproof resin layer and the stainproof layer to prevent a migration of the additives or the plasticizer and/or softener in the waterproof resin layer, into the stainproof layer.

Synthetic resins for the additive migration-preventing layer, preferably comprise at least one member selected from polyvinyl chloride resins, polyolefin resins, ionomer resins, ethylene-vinyl acetate copolymer resins, ethylene-vinyl alcohol copolymer resins, polyvinyl alcohol resins, polyvinylbutyral resins, cellulose ester-based resins, cellulose esters, polyurethane resins, polyester-based resins (including aliphatic polyester-resins), acrylic resins, polycarbonate resins, polyamide resins, epoxide resins, melamine resins, silicone resins, fluorine atom-containing resins, etc. Particularly, the synthetic resin comprising at least one member selected from fluorine atom-containing resins, acryl-based resins, polyurethane resins and polyester resins. optionally, the additive migration-preventing layer further contains one or more additives selected from stainproofing agents, ultraviolet ray absorbers, photostabilizers, antifungal agents, antibacterial agents, fillers, coloring agents, curing agents, flame retardants, etc.

When a flame retardant is added to the additive migration-preventing layer of the stainproof, waterproof sheet (1) or (2) according to the present invention, the flame retardant is preferably in the form of a solid under the conditions under which the stainproof, waterproof sheet (1) or (2) of the present invention is used, namely, should have a melting temperature of 80° C. or more. The melting temperature is more preferably 100° C. or more, still more preferably 130° C. or more. The flame retardants for the additive migration-preventing layer are preferably selected from the flame retardant compounds which are usable for the waterproof resin layer, and which have a melting temperature of 80° C. or more. Selection from inorganic flame retardants having a melting temperature of 80° C. or more is preferred from the standpoint of the stainproof property and weather resistance.

In the stainproof, waterproof sheet (1) or (2) according to the present invention, in the case where the front and back surfaces of the base fabric are coated with waterproof resin layers containing the additive or the plasticizer and/or softener, and only the front surface waterproof resin layer is coated with a stainproof layer, the additive migration-preventing layer is preferably formed on the back-surface waterproof resin layer. The formation of the additive migration-preventing layer on the back surface of the base fabric, enables, when the sheet is stored in the form of a wound roll, adhesion of the additive or plasticizer and/or softener contained in the waterproof resin layer on the back surface of the base sheet to the stainproof layer in the front surface of the sheet to be prevented. Since in cases where a hydrophilicized stainproof layer is present in the stainproof, waterproof sheet of the present invention, the reduction in stainproof property caused by adhesion of the additives such as the plasticizer is more notable than that occurred in the stainproof layer which is non-hydrophilicized, when an additive migration-preventing layer is provided on the back surface of the base fabric, and the resultant sheet is accually used, the stainproof layer can exhibit its original stainproof property. When the sheet of the present invention is rolled up, there are no particular restrictions on the rolling method, and for example, when the stainproof, waterproof sheet has a single stainproof layer formed on only one surface of the base fabric, it is preferable that the rolling-up of the sheet be carried out in such a manner that the stainproof layer comes inside of the roll. In the resultant roll, the back surface of the sheet forms an outermost periphery of the roll, thereby making it possible to prevent damage to or adhesion of stain onto the stainproof layer as often occurs during transport of the roll or other work.

In the stainproof, waterproof sheet (1) or (2) of. the present invention, the additive migration-preventing layer may be formed on the surface and/or back-surface of the sheet, by a publicly known method, for example, a topping, laminating, or coating method, with a film, solution, emulsion, etc. containing the polymer for the additive migration-preventing layer. There are no particular limitation to the thickness of the additive migration-preventing layer, but it is preferably 0.3 to 200 μm, more preferably 1 to 100 μm. If the thickness is less than 0.3 μm, the effect of preventing migration of additives from the waterproof resin layer may not be sufficient, while the effect is saturated when the thickness exceeds 200 μm, and this may instead create problems such as a hardened hand.

### EXAMPLES

The present invention will be further explained in detail through the following examples.

The products obtained in the examples and comparative examples were evaluated by measurement according to the following methods.

Evaluation Methods

1. Evaluation of Stainproof Property

A sheet specimen was subjected to an outdoor exposure test in which the sheet specimen was positioned facing southward at an inclination angle of 30° or vertical, and the stainproof property and rain streaking stain of the sheet were evaluated.

(A) Stainproof Property

The lightness difference (ΔL) of the surface of the sheet specimen positioned at an inclination angle of 30° after exposure for 1 year was compared against the sheet specimen before exposure. A CR-10 Color Reader (measurement diameter: 8 mm) by Minolta Corp. was used for measurement of the light difference, conducted on the day following a day of rainfall during the sampling period. The evaluation was based on the following scale.
3:ΔL=≧−5 (slight stain)
2:ΔL=≧−10,<5 (stain)
1:ΔL=<−10 (significant stain)
   (B) Rain Streaking Stain

The condition of rain streaking on the vertically positioned sheet specimen was visually observed and evaluated on the following scale.
3:Virtually no rain streaking stain is found.
2:Slight rain streaking stain is found.
1:Thick rain streaking stain is found.
   2. Evaluation of Abrasion Resistance

A sheet specimen was subjected to Abrasion Strength Test Method B (Scott type method) in accordance with JIS K-1096-1984, and the cohesive durability between the stainproof layer and the substrate sheet was evaluated. The test was conducted 500 times and 1000 times under a rubbing and pressing load of 9.81N (1 kgf) and the condition of adhesion on the stainproof layer was evaluated by naked eye observation as follows.
3:No change occurs
2:Flaking away of portions (less than ⅓) of stainproof layer from substrate sheet occurs.
1:Flaking away of ⅓ or more of stainproof layer from substrate sheet occurs.
   3. Heat Mass Reduction Measurement

The sheet specimen was suspended in a gear-type air drier (temperature error: ±0.1° C., product of Toyo Seiki Co., Ltd.) at 100° C. for 6 hours in accordance to JIS-K6732-1981, and the heat mass reduction was calculated by the equation shown below. The heat mass reduction measurement was conducted on the substrate sheet prior to formation of the stainproof layer. The test specimen used was cut out into a shape (#1 dumbbell) as described in JIS-K6732. The test specimen before and after the test was dried by standing for 72 hours at room temperature in a dessicator containing calcium chloride as the desiccant, and the mass of the sheet specimen was measured using a Model EU-198A Precision Electronic Balance manufactured by Kensei Kogyo Co., Ltd. The calculated value was rounded to 2 decimal places by the method described in JIS Z-8401-1961.

Heat mass reduction (%)=(mass before heating (g)−mass after heating (g))/(mass before heating (g))×100

4. Evaluation of Flame Retardant Property

The change in properties of the flame retardant used for fabrication of the stainproof waterproof sheet of the present invention by heating at high temperature was evaluated by placing the sheet specimen in a gear-type air drier (temperature error: ±0.1° C., product of Toyo Seiki Co., Ltd.) set to a prescribed temperature (79.9° C., 99.9° C., or 129.9° C.) for 30 minutes; taking up the heated specimen from the drier; judging weather the flame retardant was melted or not using a digital microscope (SCOPEMAN™, product of Moritex Co., Ltd.), and defining the melting temperature of the flame detergent as follows.
1:130° C. or more
2:100° C., or more but less than 130° C.
3:80° C., ormore but less than 100° C.
4:Less than 80° C.

### Example 1

The base fabric used was a non-coarse woven fabric composed of polyester filament yarns, having the following weave structure.

<Polyester Non-coarse Woven Fabric>
556 dtex×556 dtex (500 d×500 d)
35×36 (yarns/25.4 mm)

The front and back surfaces of the base fabric were coated with a polyurethane resin dispersion of Composition 1 as shown below, using a comma coater, and then dried at 120° C. for 5 minutes to form front and back waterproof resin layers having a total dry mass of 150 g/m² on the front and back surfaces.

Composition 1

| Component | Parts by mass |
|---|---|
| Aqueous polyurethane resin | 100 |
| (ADEKA BONTIGHTER ™ HUX-386, solid content: | |
| 31 mass %, product of Asahi Denka Co., Ltd.) | |
| Melamine isocyanurate | 20 |
| (MC-640 ™, mean particle size: 1 to 5 μm, | |
| melting temperature class: 1, product of | |
| Nissan Chemical Industries Co., Ltd.) | |
| Rutile type titanium oxide | 5 |
| Calcium carbonate | 10 |
| Thickener | 0.5 |
| [Note: | |
| All parts are by mass in terms of solid content] | |
| The surface-side waterproof resin layer was coated with a coating solution of Composition 2 shown below, using a gravure coater and dried at 120° C. for 2 minutes, to form an stainproof | |
| # layer having a dry mass of 4 g/m², to obtain a stainproof, waterproof sheet of the present invention. The evaluation results for the obtained sheet are shown in Table 1. | |

Composition 2

| Component | Parts by mass |
|---|---|
| Polyurethane resin | 70 |
| (CRISVON ™ NY-331, solid content: 25 mass %, | |
| product of Dainippon Ink & Chemicals, Inc.) | |
| Hexamethylene diisocyanate | 5 |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |

[Note:
All parts are by mass in terms of solid components]

### Example 2

A stainproof, waterproof sheet of the present invention was fabricated in the same manner as in Example 1, except that the wet precipitated fine silica particles (25 parts by mass) in the stainproof layer coating solution of Composition 2 above were replaced with wet precipitated fine silica particles with a BET specific surface area of 40 m²/g (NIPSIL™ E-75, mean aggregate particle size: 2.3 μm, product of Nippon Silica Industrial Co., Ltd.). The evaluation results for the obtained sheet are shown in Table 1.

### Example 3

A stainproof waterproof sheet of the present invention was fabricated in the same manner as in Example 1, except that the wet precipitated fine silica particles (25 parts by mass) in the stainproof layer coating solution of Composition 2 above were replaced with wet precipitated fine silica particles with a BET specific surface area of 135 m²/g (NIPSIL™ E-1011, mean aggregate particle size: 1.5 μm, product of Nippon Silica Industrial Co., Ltd.). The evaluation results for the obtained sheet are shown in Table 1.

### Example 4

A stainproof, waterproof sheet of the present invention was fabricated in the same manner as in Example 1, except that the wet precipitated fine silica particles (25 parts by mass) in the stainproof layer coating solution of Composition 2 shown above were replaced with wet precipitated silica fine particles having a BET specific surface area of 150 m²/g (NIPSIL™ NS-P, mean aggregate particle size: 8.0 μm, product of Nippon Silica Industrial Co., Ltd.). The evaluation results for the obtained sheet are shown in Table 1.

### Example 5

A stainproof, waterproof sheet of the present invention was fabricated in the same manner as in Example 1, except that the wet precipitated fine silica particles (25 parts by weight) in the antifouling layer coating solution of Composition 2 shown above were replaced with wet precipitated fine silica particles having a BET specific surface area of 200 m²/g (NIPSIL™ L-300, mean aggregate particle size: 7.0 μm, product of Nippon Silica Industrial Co., Ltd.). The evaluation results for the obtained sheet are shown in Table 1.

### Example 6

A stainproof, waterproof sheet of the present invention was fabricated in the same manner as in Example 1, except that the wet precipitated fine silica particles (25 parts by mass) in the stainproof layer coating solution of Composition 2 shown above were replaced with wet precipitated fine silica particles having a BET specific surface area of 200 m²/g (NIPSIL™ VN-3, mean aggregate particle size: 18.0 μm, product of Nippon Silica Industrial Co., Ltd.). The evaluation results for the obtained sheet are shown in Table 1.

### Example 7

A stainproof, waterproof sheet of the present invention was fabricated in the same manner as in Example 1, except that the wet precipitated fine silica particles (25 parts by mass) in the stainproof layer coating solution of Composition 2 shown above were replaced with wet-produced fine silica particles having a BET specific surface area of 275 m²/g (FINESIL™ X-37, mean aggregate particle size: 2.7 μm, product of Tokuyama Corp.). The evaluation results for the obtained sheet are shown in Table 1.

### Example 8

A stainproof, waterproof sheet of the present invention was fabricated in the same manner as in Example 1, except that the wet precipitated fine silica particles (25 parts by mass) in the stainproof layer coating solution of Composition 2 shown above were replaced with wet precipitated fine silica particles having a BET specific surface area of 280 m²/g (NIPSIL™ HD-2, mean aggregate particle size: 2.5 μm, product of Nippon Silica Industrial Co., Ltd.). The evaluation results for the obtained sheet are shown in Table 1.

### Example 9

A stainproof, waterproof sheet of the present invention was fabricated in the same manner as in Example 1, except that the wet precipitated fine silica particles (25 parts by mass) in the stainproof layer coating solution of Composition 2 shown above were replaced with wet precipitated fine silica particles having a BET specific surface area of 301 m²/g (FINESIL™ X-60, mean aggregate particle size: 6.5 μm, product of Tokyuma Corp.). The evaluation results for the obtained sheet are shown in Table 1.

### Example 10

A stainproof, waterproof sheet of the present invention was fabricated in the same manner as in Example 1, except that the wet precipitated fine silica particles (25 parts by mass) in the stainproof layer coating solution of Composition 2 shown above were replaced with dry-produced fine silica particles having a BET specific surface area of 200 m²/g (AEROSIL™ TT-600, mean primary particle size: 12 nm, product of Nippon Aerosil Co., Ltd.). The evaluation results for the obtained sheet are shown in Table 1.

### Example 11

A stainproof, waterproof sheet of the present invention was fabricated in the same manner as in Example 1, except that the wet precipitated fine silica particles (25 parts by mass) in the stainproof layer coating solution of Composition 2 shown above were replaced with dry method fine silica particles having a BET specific surface area of 380 m²/g (AEROSIL™ 380, mean primary particle size: 7 nm, product of Nippon Aerosil Co., Ltd.). The evaluation results for the obtained sheet are shown in Table 1.

### Example 12

A stainproof, waterproof sheet of the present invention was fabricated in the same manner as in Example 1, except that the wet precipitated fine silica particles (25 parts by mass) in the stainproof layer coating solution of Composition 2 shown above were replaced with wet gel method fine silica particles having a BET specific surface area of 212 m²/g (CARPLEX™ BS-312BF, mean aggregate particle size: 3.1 μm, product of Shionogi Co., Ltd.). The evaluation results for the obtained sheet are shown in Table 1.

### Example 13

A stainproof, waterproof sheet of the present invention was fabricated in the same manner as in Example 1, except that the wet precipitated fine silica particles (25 parts by mass) in the stainproof layer coating solution of Composition 2 shown above were replaced with wet gel method fine silica particles having a BET specific surface area of 300 m²/g (NIPGEL™ AZ-600, mean aggregate particle size: 5.0 μm, product of Nippon Silica Industrial Co., Ltd.). The evaluation results for the obtained sheet are shown in Table 1.

### Example 14

A stainproof, waterproof sheet of the present invention was fabricated in the same manner as in Example 1, except that the wet precipitated fine silica particles (25 parts by mass) in the stainproof layer coating solution of Composition 2 shown above were replaced with wet gel method fine silica particles having a BET specific surface area of 416 m²/g (CARPLEX™ BS-304N, mean aggregate particle size: 10.4 μm, product of Shionogi Co., Ltd.). The evaluation results for the obtained sheet are shown in Table 1.

### Example 15

A stainproof, waterproof sheet of the present invention was fabricated in the same manner as in Example 1, except that the wet precipitated fine silica particles (25 parts by mass) in the stainproof layer coating solution of Composition 2 shown above were replaced with the same dry method silica fine particles having a BET specific surface area of 200 m²/g as used in Example 10 (AEROSILS™ TT-600, mean primary particle size: 12 μm, product of Nippon Aerosil Co., Ltd.), the dry method fine silica particles were added in an amount of 5 parts by mass, and the amount of polyurethane resin added was changed from 70 parts by mass to 90 parts by mass. The evaluation results for the obtained sheet are shown in Table 1.

### Example 16

A stainproof, waterproof sheet was fabricated in the same manner as in Example 1, except that the wet precipitated fine silica particles (25 parts by mass) in the stainproof layer coating solution of Composition 2 shown above were replaced with the same dry method fine silica particles having a BET specific surface area of 200 m²/g as used in Example 10 (AEROSIL™ TT-600, mean primary particle size: 12 μm, product of Nippon Aerosil Co., Ltd.), the dry method silica fine particles were added in an amount of 70 parts by mass, and the amount of polyurethane resin added was changed from 70 parts by mass to 25 parts by mass. The evaluation results of the obtained sheet are shown in Table 1.

### Example 17

A stainproof, waterproof sheet was fabricated in the same manner as in Example 1, except that the wet precipitated fine silica particles (25 parts by mass) in the stainproof layer coating solution of Composition 2 shown above were replaced with wet gel method fine silica particles having a BET specific surface area of 750 m²/g (NIPGEL™ CX-200, mean particle size: 2.2 μm, product of Nippon Silica Industrial Co., Ltd.), the wet gel method fine silica particles were added in an amount of 60 parts by mass, and the amount of polyurethane resin added was changed from 70 parts by mass to 35 parts by mass. The evaluation results of the obtained sheet are shown in Table 1.

### Example 18

A stainproof, waterproof sheet of the present invention was fabricated in the same manner as in Example 1, except that the wet precipitated fine silica particles (25 parts by mass) in the stainproof layer coating solution of Composition 2 shown above were replaced with a dispersion of fine amorphous silica particles having a BET specific surface area of 170 m²/g (SNOWTEX™ MEK-ST, solid concentration: 30 wt %, mean primary particle size: 15 nm, product of Nissan Chemical Industries, Ltd.), the fine amorphous silica particles were added in an amount of 50 parts by mass (based on solid content), and the amount of polyurethane resin added was changed from 70 parts by mass to 45 parts by mass (based on solid content). The evaluation results for the obtained sheet are shown in Table 1.

### Comparative Example 1

A comparison sheet was fabricated in the same manner as in Example 1, except that no wet precipitated fine silica particles were added to the stainproof layer coating solution of Composition 2 shown above, and the amount of polyurethane resin added was changed from 80 parts by mass to 100 parts by mass. The evaluation results for the obtained sheet are shown in Table 1.

### Comparative Example 2

A comparison sheet was fabricated in the same manner as in Example 1, except that the wet precipitated fine silica particles (25 parts by mass) in the stainproof layer coating solution of Composition 2 shown above were replaced with fine crystalline silica particles having a BET specific surface area of 16 m²/g (SILLIKOLLOID™ P87, mean particle size: 1.8 μm, product of Hoffmann Mineral Co., Ltd.), the fine crystalline silica particles were added in an amount of 60 parts by weight, and the amount of polyurethane resin added was changed from 70 parts by mass to 35 parts by mass. The evaluation results for the obtained sheet are shown in Table 1.

### Comparative Example 3

A comparison sheet was fabricated in the same manner as in Example 1, except that the wet precipitated fine silica particles (25 parts by mass) in the stainproof layer coating solution of Composition 2 shown above were replaced with precipitated fine calcium carbonate particles having a BET specific surface area of 12.3 m²/g (ED-I™, mean particle size: 1 μm, product of Komesho Sekkaikogyo Co., Ltd.), the fine calcium carbonate particles were added in an amount of 60 parts by mass, and the amount of polyurethane resin added was changed from 70 parts by mass to 35 parts by mass. The evaluation results for the obtained sheet are shown in Table 1.

### Comparative Example 4

A comparison sheet was fabricated in the same manner as in Example 1, except that the wet precipitated fine silica particles (25 parts by mass) in the stainproof layer coating solution of Composition 2 shown above were replaced with fine alumina particles having a BET specific surface area of 100 m²/g (ALUMINIUM OXIDE C™, mean primary particle size: 13 nm, product of Nippon Aerosil Co., Ltd.), the fine alumina particles were added in an amount of 60 parts by mass, and the amount of polyurethane resin added was changed from 70 parts by mass to 35 parts by mass. The evaluation results for the obtained sheet are shown in Table 1.

TABLE 1

| | Substrate sheet | | | | | | | | |
|---|---|---|---|---|---|---|---|---|---|
| | | Waterproof resin | | Stainproof layer | | | | | |
| | | layer | | | Fine amorphous silica particles (or other fine particles) | | | | |
| | | | Plasti- | | | BET | Mean | Mean | |
| | Fiber type | Synthetic | cizer | Synthetic | Production | specific | primary | secondary | Amount |
| | of base | resin | or | resin | process | surface | particle | particle | added |
| | fabric | type | softener | type | (or type) | area (m²/g) | size | size | (wt %) |
| Example | | | | | | | | | |
| 1 | Poly- | Poly- | — | Poly- | wet precipitation | 120 | — | 3.0 μm | 25 |
| | ester | urethane | | urethane | | | | | |
| 2 | | | | | wet precipitation | 40 | — | 2.3 μm | 25 |
| 3 | | | | | wet precipitation | 135 | — | 1.5 μm | 25 |
| 4 | | | | | wet precipitation | 150 | — | 8.0 μm | 25 |
| 5 | | | | | wet precipitation | 200 | — | 7.0 μm | 25 |
| 6 | | | | | wet precipitation | 200 | — | 18.0 μm | 25 |
| 7 | | | | | wet method | 275 | — | 2.7 μm | 25 |
| 8 | | | | | wet precipitation | 280 | — | 2.5 μm | 25 |
| 9 | | | | | wet method | 301 | — | 6.5 μm | 25 |
| 10 | | | | | dry method | 200 | 12 nm | — | 25 |
| 11 | | | | | dry method | 380 | 7 nm | — | 25 |
| 12 | | | | | wet gel method | 212 | — | 3.1 μm | 25 |
| 13 | | | | | wet gel method | 300 | — | 5.0 μm | 25 |
| 14 | | | | | wet gel method | 416 | — | 10.4 μm | 25 |
| 15 | | | | | dry method | 200 | 12 nm | — | 5 |
| 16 | | | | | dry method | 200 | 12 nm | — | 70 |
| 17 | | | | | wet gel method | 750 | — | 2.2 μm | 60 |
| 18 | | | | | colloidal silica | 170 | 15 nm | — | 50 |
| Comparative | | | | | | | | | |
| Example | | | | | | | | | |
| 1 | Poly- | Poly- | — | Poly- | — | — | — | — | — |
| | ester | urethane | | urethane | | | | | |
| 2 | | | | | crystalline silica | 16 | 1.8 μm | — | 60 |
| 3 | | | | | calcium carbonate | 12.3 | 1.0 μm | — | 60 |
| 4 | | | | | alumina | 100 | 13 nm | — | 60 |

| Evaluation results | | | |
|---|---|---|---|
| | | Stainproof property | |
| Heat mass | | Lightness difference | Rain streaking |
| reduction | Abrasion resistance | (ΔL) | stain |

| | of base | 9.81 N × 500 | 9.81 N × 1000 | After 6 | | After 12 | | After | After |
|---|---|---|---|---|---|---|---|---|---|
| | sheet (%) | times | times | months | | months | | 6 mos. | 12 mos. |
| Example | | | | | | | | | |
| 1 | 0.00 | 3 | 3 | 3 | −2.6 | 3 | −3.6 | 3 | 3 |
| 2 | 0.00 | 3 | 3 | 3 | −3.8 | 2 | −6.2 | 3 | 2 |
| 3 | 0.00 | 3 | 3 | 3 | −2.7 | 3 | −3.8 | 3 | 3 |
| 4 | 0.00 | 3 | 3 | 3 | −3.1 | 3 | −4.5 | 3 | 3 |
| 5 | 0.00 | 3 | 3 | 3 | −2.9 | 3 | −4.3 | 3 | 3 |
| 6 | 0.00 | 3 | 3 | 3 | −3.4 | 3 | −4.7 | 3 | 3 |
| 7 | 0.00 | 3 | 3 | 3 | −2.7 | 3 | −3.8 | 3 | 3 |
| 8 | 0.00 | 3 | 3 | 3 | −2.7 | 3 | −3.9 | 3 | 3 |
| 9 | 0.00 | 3 | 3 | 3 | −3.1 | 3 | −4.4 | 3 | 3 |
| 10 | 0.00 | 3 | 3 | 3 | −2.6 | 3 | −3.7 | 3 | 3 |
| 11 | 0.00 | 3 | 3 | 3 | −2.6 | 3 | −3.6 | 3 | 3 |
| 12 | 0.00 | 3 | 3 | 3 | −3.3 | 3 | −4.6 | 3 | 3 |
| 13 | 0.00 | 3 | 3 | 3 | −3.4 | 3 | −4.7 | 3 | 3 |
| 14 | 0.00 | 3 | 3 | 3 | −3.5 | 3 | −4.9 | 3 | 3 |
| 15 | 0.00 | 3 | 3 | 3 | −4.7 | 2 | −7.1 | 3 | 2 |
| 16 | 0.00 | 2 | 2 | 3 | −2.2 | 3 | −3.0 | 3 | 3 |
| 17 | 0.00 | 3 | 2 | 3 | −4.0 | 2 | −6.5 | 3 | 2 |
| 18 | 0.00 | 3 | 3 | 3 | −3.0 | 3 | −4.9 | 3 | 3 |
| Comparative | | | | | | | | | |
| Example | | | | | | | | | |
| 1 | 0.00 | 3 | 3 | 2 | −8.0 | 1 | −12.9 | 1 | 1 |
| 2 | 0.00 | 2 | 2 | 2 | −5.7 | 1 | −10.5 | 2 | 1 |
| 3 | 0.00 | 3 | 2 | 1 | −6.9 | 1 | −11.9 | 1 | 1 |
| 4 | 0.00 | 3 | 3 | 1 | −6.2 | 1 | −11.4 | 1 | 1 |

As is clear from Table 1, the sheets of Examples 1 to 18 each exhibited a satisfactory stainproof property. The stainproof layers comprising wet precipitated fine silica particles and dry method fine silica particles exhibited a particularly excellent stainproof property. On the other hand, the sheet of Comparative Example 1 contained no fine amorphous silica particles and therefore exhibited an inferior stainproof property. The sheet of Comparative Example 2 employed fine crystalline silica particles and therefore exhibited an inferior stainproof property. The sheets of Comparative Examples 3 and 4 likewise had the fine amorphous silica particles replaced with other fine particles, and therefore exhibited an inferior stainproof property.

### Example 19

A non-coarse woven fabric composed of polypropylene staple fibers and having the following weaving structure was employed as a base fabric.
<Polyester Non-coarse Textile>

$$\frac{492 dtex \times 492 dtex ( 24 yarn count / 2 \times 24 yarn count / 2 )}{35 \times 36 ( yarns / 25.4 mm )}$$

The front and back surfaces of the base fabric were laminated with a waterproof resin layer composed of a ethylene-vinyl acetate copolymer resin film (thickness: 0.15 mm) having a Composition 3 shown below, and shaped by calender treatment, to form waterproof resin layers (1).

### Composition 3

| Component | Parts by mass |
|---|---|
| Ethylene-vinyl acetate copolymer resin | 100 |
| (Vinyl acetate copolymerization rate: 19 wt %) | |
| Red phosphorus (melting temperature class: 1) | 20 |
| Aluminum hydroxide (melting temperature class: 1) | 10 |
| Rutile titanium dioxide | 5 |
| Hindered phenol compound antioxidant | 0.2 |
| Phosphoric acid ester lubricant | 0.5 |

A surface of one of the waterproof resin layers (1) was heat laminated with a waterproof resin layer film having Composition 4 shown below and shaped to a thickness of 0.15 mm by calender treatment, to form a waterproof resin layer (2) to fabricate a substrate sheet.

### Composition 4

| Component | Parts by mass |
|---|---|
| Ethylene-vinyl acetate copolymer resin | 80 |
| (Vinyl acetate copolymerization rate: 19 wt %) | |
| Maleic anhydride-modified polyethylene resin | 20 |
| Magnesium hydroxide (melting temperature class: 1) | 50 |
| Rutile titanium dioxide | 5 |
| Hindered amine-based lightstabilizer | 0.5 |
| Hindered phenol-based antioxidant | 0.2 |
| Phosphoric acid ester-based lubricant | 0.5 |

Both waterproof resin layer surfaces of the substrate sheet were subjected to corona discharge treatment in air, and then both waterproof resin layer surfaces were coated with a stainproof layer, formed from a coating solution of Composition 5 shown below, by using a gravure coater, and dried at 120° C. for 2 minutes, to form a stainproof layers having a dry mass of 4 g/m², to fabricate a stainproof waterproof sheet of the present invention. The evaluation results of the obtained sheet are shown in Table 2.

### Composition 5

| Component | Parts by mass |
|---|---|
| Tetrafluoroethylene-vinyl ether copolymer resin | 45 |
| (LUMIFLON ™, product of Asahi Glass Co., Ltd.) | |
| Acryl resin | 25 |
| (LUCKSKIN ™ Z290A, solid content: 17 wt %, | |
| product of Seiko Kasei Co., Ltd.) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |
| Hexamethylene diisocyanate | 5 |

[Note:
All parts are by mass in terms of solid content]

### Example 20

The same polypropylene non-coarse woven fabric as that used in Example 19 was used as a base fabric, and both the front and back surfaces of the base fabric were laminated with chlorinated polyethylene resin films (thickness: 0.20 mm) having Composition 6 shown below, and shaped by a calender treatment, to form a waterproof resin layers. A substrate sheet was obtained.

### Composition 6

| Component | Parts by mass |
|---|---|
| Chlorinated polyethylene-based resin | 100 |
| (ALCRYN ™ 2080NC, product of Mitsui-Du Pont | |
| Polychemicals Co., Ltd.) | |
| Rutile titanium dioxide | 5 |
| Organotin-based stabilizer | 2 |
| Hindered phenol-based antioxidant | 0.2 |
| Phosphoric acid ester-based lubricant | 0.2 |

A coating solution of Composition 7 shown below for a stainproof layer was coated on one of the waterproof resin layers of the substrate sheet using a gravure coater, and then dried at 120° C. for 2 minutes, to form a stainproof layer having a dry mass of 4 g/m², to fabricate a stainproof, waterproof sheet of the present invention. The evaluation results for the obtained sheet are shown in Table 2.

### Composition 7

| Component | Parts by mass |
|---|---|
| Chlorinated polypropylene resin | 30 |
| (HARDLEN ™ 11-L, solid concentration: | |
| 15 wt %, product of Toyo Kasei Kogyo Co., | |
| Ltd.) | |
| Acryl resin (LUCKSKIN ™ Z-290A, solid | 30 |
| concentration: 17 wt %, product of Seiko | |
| Kasei Co., Ltd.) | |
| Acryl resin-based high-molecular | 15 |
| ultraviolet ray absorber | |
| (PUVA-30M ™, methyl methacrylate | |
| copolymerization rate: 70 wt %, product | |
| of Otsuka Chemical Holdings Co., Ltd.) | |
| Wet precipitated fine silica particles | 25 |
| (NIPSIL ™ E-200, BET specific surface | |
| area: 120 m²/g, mean aggregate particle | |
| size: 3.0 μm, product of Nippon Silica | |
| Industrial Co., Ltd.) | |
| Hindered amine-based lightstabilizer | 0.2 |

[Note:
All parts are by mass in terms of solid content]

### Example 21

The same polyester non-coarse woven fabric as that for Example 1 was used as a base fabric, and both front and back surfaces of the base fabric were coated with resin layers by dipping the base fabric in a fluorine atom-containing resin dispersion of Composition 8 shown below, and dried at 120° C. for 5 minutes to form adhesive resin layers with a total dry mass of 20 g/m².

### Composition 8

| Component | Parts by mass |
|---|---|
| Tetrafluoroethylene-hexafluoropropylene- | 100 |
| vinylidene fluoride copolymer resin | |
| (THV-350C ™, solid content: 5 wt %, product of | |
| Sumitomo 3M Ltd.) | |
| Silane coupling agent | 5 |

[Note:
All parts are by mass in terms of solid content.]

Each of the adhesive resin layers on the front and back surfaces of the base fabric was heat laminated with a waterproof resin film having Composition 9 shown below, and shaped to a thickness of 0.2 mm by a calender treatment, for formation of waterproof resin layers, to fabricate a substrate sheet.

### Composition 9

| Component | Parts by wt. |
|---|---|
| Tetrafluoroethylene-hexafluoropropylene- | 100 |
| vinylidene fluoride copolymer resin | |
| (THV-400G ™, product of Sumitomo 3M Ltd.) | |
| Phosphoric acid ester-based lubricant | 0.5 |
| Hindered phenol-based antioxidant | 0.2 |

One surface of the substrate sheet was coated with a stainproof layer formed from a coating solution of Composition 10 shown below (solid concentration: 20 wt %, solvent: MEK), using a gravure coater, and then dried at 120° C. for 2 minutes and subsequently heat treated at 180° C. for 1 minute. A stainproof layer having a dry mass of 4 g/m², was formed and a stainproof, waterproof sheet of the present invention was obtained. The evaluation results for the obtained sheet are shown in Table 2.

### Composition 10

| Component | Parts by mass |
|---|---|
| Tetrafluoroethylene-vinylidene fluoride | 75 |
| copolymer resin | |
| (KYNAR ™ 7201, product of Elf Atochem Japan) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |

[Note:
All “parts” are by mass in terms of solid content.]

### Example 22

The same polyester non-coarse woven fabric as that in Example 1 was used as a base fabric, both the front and back surfaces of the base fabric were laminated with polyester films having Composition 11 shown below for the waterproof layer, and shaped to a thickness of 0.2 mm by an extrusion molder (T-die), for formation of waterproof resin layers. A substrate sheet was obtained.

### Composition 11

| Component | Parts by mass |
|---|---|
| Polyester resin | 100 |
| (PELPRENE ™ P-40B, product of Toyobo Co., Ltd.) | |
| Condensation product of 1,3-Phenylenebis (diphenyl | 15 |
| phosphate) | |
| (FYROLFLEX ™ RDP, melting point class: 4, | |
| product of Akzo Kashima Ltd.) | |
| Rutile titanium dioxide | 5 |
| Hindered phenol-based antioxidant | 0.2 |
| Carbodiimide (hydrolysis inhibitor) | 0.5 |
| (STABAXOL ™ P-100, product of Sumitomo | |
| Bayer Urethane Co., Ltd.) | |
| Polyolefin-based lubricant | 0.2 |

One surface of the substrate sheet was coated with a coating solution of Composition 12 shown below, by using a gravure coater, and dried at 120° C. for 2 minutes, to form a stainproof layer having a dry mass of 4 g/m². A stainproof waterproof sheet of the present invention was obtained. The evaluation results for the obtained sheet are shown in Table 2.

### Composition 12

| Component | Parts by mass |
|---|---|
| Polyester resin | 70 |
| (PESRESIN ™ S-110, solid concentration: | |
| 30 wt %, product of Takamatsu Oil & Fat | |
| Co., Ltd.) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |
| Hexamethylene diisocyanate | 5 |
| Carbodiimide (hydrolysis inhibitor) | 0.5 |
| (STABAXOL ™ P, Product of Sumitomo Bayer | |
| Urethane Co., Ltd.) | |

[Note:
All parts are by mass in terms of solid content]

### Example 23

A non-coarse woven fabric composed of aliphatic polyester (polylactic acid-based) fiber yarns, having the following weaving structure was employed as a base fabric.
<Aliphatic Polyester Non-coarse Woven Fabric>

$$\frac{492 dtex \times 492 dtex ( 24 yarn count / 2 \times 24 yarn count / 2 )}{40 \times 40 ( yarns / 25.4 mm )}$$

Both the front and back surfaces of the base fabric were coated with a aliphatic polyester resin dispersion of Composition 13 shown below, by using a comma coater, and then dried at 120° C. for 5 minutes, to form waterproof resin layers having a total dry mass of 150 g/m². A substrate sheet was obtained.

### Composition 13

| Component | Parts by mass |
|---|---|
| Aqueous aliphatic polyester resin | 70 |
| (LANDI ™ CP-05A, solid concentration: 40 wt %, | |
| product of Miyoshi Oil & Fat Co., Ltd.) | |
| Aqueous vinyl acetate-ethylene copolymer resin | 30 |
| (SUMIKAFLEX ™ 752, solid concentration: 50 wt %, | |
| product of Sumitomo Chemical Co., Ltd.) | |
| Melamine-coated polyammonium phosphate | 10 |
| (TERRAJU ™ C-60, mean particle size: 7.5 μm, | |
| melting temperature class: 1, product of | |
| Chisso Corporation) | |
| Benzoguanamine | 10 |
| (EPOSTAR ™ GP-50, mean particle size: 5 μm, | |
| melting temperature class: 1, product of | |
| Nippon Shokubai Co., Ltd.) | |
| Oxazoline-based curing agent | 2 |
| Rutile titanium dioxide | 5 |
| Hindered phenol-based antioxidant | 0.2 |
| Thickener | 1 |

One surface of the substrate sheet was coated with a coating solution of Composition 14 shown below by using a gravure coater, and then dried at 120° C. for 2 minutes, to form a stainproof layer having a dry mass of 4 g/m². A stainproof, waterproof sheet of the present invention was obtained. The evaluation results for the obtained sheet are shown in Table 2.

### Composition 14

| Component | Parts by mass |
|---|---|
| Aqueous aliphatic polyester resin | 75 |
| (LANDI ™ CP-05A, solid concentration: 40 wt %, | |
| product of Miyoshi Oil & Fat Co., Ltd.) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |
| Carbodiimide (hydrolysis inhibitor) | 0.5 |
| (STABAXOL ™ P, product of Sumitomo Bayer | |
| Urethane Co., Ltd.) | |

[Note:
All parts are by mass in terms of solid content]

### Example 24

The same polyester non-coarse woven fabric as that in Example 1 was used as a base fabric, and both the front and back surfaces of the basic fabric were laminated with vinyl chloride-vinyl acetate copolymer resin films of Composition 15 shown below, and shaped to a thickness of 0.2 mm by calender treatment, to form a waterproof resin layers. A substrate sheet was obtained.

### Composition 15

| Component | Parts by mass |
|---|---|
| Vinyl chloride-vinyl acetate copolymer resin | 100 |
| Antimony trioxide (melting temperature class: 1) | 10 |
| Rutile titanium dioxide | 5 |
| Ba—Zn based stabilizer | 2 |
| Hindered phenol-based antioxidant | 0.2 |

One surface of the substrate sheet was coated with a coating solution of Composition 16 shown below, by using a gravure coater, and then dried at 120° C. for 2 minutes, to form a stainproof layer having a dry mass of 4 g/m². A stainproof, waterproof sheet of the present invention was obtained. The evaluation results for the obtained sheet are shown in Table 2.

### Composition 16

| Component | Parts by mass |
|---|---|
| Fluorine-modified acrylic resin | 55 |
| (LUCKSKIN ™ Z-899, solid concentration: | |
| 10 wt %, product of Seiko Kasei Co., Ltd.) | |
| Acrylic resin-based high-molecular | 15 |
| ultraviolet ray absorber | |
| (PUVA-30M ™, methyl methacrylate | |
| copolymerization rate: 70 wt %, product of | |
| Otsuka Chemical Holdings Co., Ltd.) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |

[Note:
All parts are by mass in terms of solid content]

TABLE 2

| | Substrate sheet | | | Stainproof layer | | | | | |
|---|---|---|---|---|---|---|---|---|---|
| | | Waterproof resin layer | | | Amorphous fine silica particles | | | | |
| | | | Plasti- | | | BET | | | |
| | | | cizer | | | specific | Mean | Mean | |
| | | | or | | | surface | primary | secondary | Amount |
| | | Synthetic resin | soft- | Synthetic | | area | particle | particle | added |
| Example | Fiber type | type | ener | resin type | Type | (m²/g) | size | size | (mass %) |
| 19 | polypropylene | EVA | — | fluorine- | wet | 120 | — | 3.0 μm | 25 |
| | | | | containing | precipi- | | | | |
| | | | | resin | tation | | | | |
| | | | | acryl resin | | | | | |
| 20 | polypropylene | chlorinated PE | — | chlorinated | wet | 120 | — | 3.0 μm | 25 |
| | | | | PP | precipi- | | | | |
| | | | | acryl resin | tation | | | | |
| 21 | polyester | fluorine atom- | — | fluorine- | wet | 120 | — | 3.0 μm | 25 |
| | | containing | | containing | precipi- | | | | |
| | | resin | | resin | tation | | | | |
| 22 | polyester | polyester | — | polyester | wet | 120 | — | 3.0 μm | 25 |
| | | | | | precipi- | | | | |
| | | | | | tation | | | | |
| 23 | aliphatic | aliphatic | — | aliphatic | wet | 120 | — | 3.0 μm | 25 |
| | polyester | polyester | | polyester | precipi- | | | | |
| | | | | | tation | | | | |
| 24 | polyester | vinyl chloride- | — | fluorine- | wet | 120 | — | 3.0 μm | 25 |
| | | vinyl acetate | | modified | precipi- | | | | |
| | | copolymer | | acryl resin | tation | | | | |

| | Evaluation results | | |
|---|---|---|---|
| | | Stainproof property | |
| Heat mass | | Brightness | Rain streaking |
| reduction | Abrasion resistance | difference (ΔL) | stain |

| | of base | 9.81 N × 500 | 9.81 N × 1000 | After 6 | | After 12 | | After | After |
|---|---|---|---|---|---|---|---|---|---|
| Example | sheet (%) | times | times | months | | months | | 6 mos. | 12 mos. |
| 19 | 0.05 | 3 | 3 | 3 | −2.5 | 3 | −3.5 | 3 | 3 |
| 20 | 0.04 | 3 | 3 | 3 | −3.2 | 3 | −4.8 | 3 | 3 |
| 21 | 0.05 | 3 | 3 | 3 | −2.2 | 3 | −3.0 | 3 | 3 |
| 22 | 0.09 | 3 | 3 | 3 | −3.0 | 3 | −4.2 | 3 | 3 |
| 23 | 0.00 | 3 | 3 | 3 | −3.3 | 3 | −4.9 | 3 | 3 |
| 24 | 0.01 | 3 | 3 | 3 | −2.7 | 3 | −3.6 | 3 | 3 |

As is clear from Table 2, it was confirmed that the sheets of Examples 19 to 24 exhibit a satisfactory stainproof property, regardless of the type of synthetic resin contained in the waterproof resin layer or stainproof layer.

### Example 25

The same polyester non-coarse woven fabric as that used in Example 1 was used as a base fabric, both front and back surfaces of the base fabric were coated with a polyvinyl chloride resin dispersion of Composition 17 shown below and heat treated at 180° C. for 2 minutes to form adhesive layers having a total dry mass of 80 g/m².

### Composition 17

| Component | Parts by mass |
|---|---|
| Polyvinyl chloride resin for past-processing | 100 |
| Tris-2-ethylhexyl trimellitate | 80 |
| (molecular weight: 547) | |
| Epoxidized soybean oil | 3 |
| Organotin-based stabilizer | 2 |
| Hindered phenol-based antioxidant | 0.2 |
| Antimony trioxide | 10 |

[Note:
All parts are by weight in terms of solid content]

Both adhesive layers were heat laminated with polyvinyl chloride resin films of Composition 18 shown below, and shaped to a thickness of 0.2 mm by a calender treatment, to form a waterproof resin layers. A substrate sheet was obtained.

### Composition 18

| Component | Parts by mass |
|---|---|
| Polyvinyl chloride resin for calender-processing | 100 |
| Diisodecyl phthalate | 60 |
| (molecular weight: 446) | |
| Ba—Zn based stabilizer | 2 |
| Phosphite-based stabilizer | 1 |
| Hindered phenol-based antioxidant | 0.2 |
| Antimony trioxide | 10 |
| Rutile titanium oxide | 5 |

One surface of the substrate sheet was coated with a coating solution of Composition 19 shown below by using a gravure coater, and then dried at 120° C. for 2 minutes, to form a stainproof layer having a dry mass of 4 g/m². A stainproof, waterproof sheet of the present invention was obtained. The evaluation results for the obtained sheet are shown in Table 3.

### Composition 19

| Component | Parts by mass |
|---|---|
| Acrylic resin | 75 |
| (LUCKSKIN ™ Z-290A, solid content: 17 mass %, | |
| product of Seiko Kasei Co., Ltd.) | |
| Wet precipitated silica fine particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |

[Note:
All parts are by mass in terms of solid content.]

### Example 26

A stainproof, waterproof sheet was produced in the same manner as in Example 25, except that the diisodecyl phthalate (60 parts by mass) used as a plasticizer in the polyvinyl chloride resin film of Composition 18 shown above for the waterproof resin layer was replaced by 60 parts by mass of diisodecyl adipate (molecular weight: 427). The evaluation results for the obtained sheet are shown in Table 3.

### Example 27

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with an epoxidized soybean oil (70 parts by mass). The evaluation results for the obtained sheet are shown in Table 3.

### Example 28

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with tris-2-ethylhexyl trimellitate (70 parts by mass). The evaluation results for the obtained sheet are shown in Table 3.

### Example 29

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with tetra-2-ethylhexyl pyromellitate (70 parts by mass). The evaluation results for the obtained sheet are shown in Table 3.

### Example 30

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 70 parts by mass of a pentaerythritol ester-based -plasticizer (UL-6™, product of Asahi Denka Co., Ltd.). The evaluation results for the obtained sheet are shown in Table 3.

### Example 31

A stainproof, waterproof sheet was produced in the same manner as in Example 25, except that the diisodecyl phthalate (60 parts by weight) used as the plasticizer in the polyvinyl chloride resin film of Composition 18 shown above for the waterproof resin layer was replaced with 70 parts by mass of an adipic acid-based polyester plasticizer (PN-400™, molecular weight: 2000, product of Asahi Denka Co., Ltd.). The evaluation results for the obtained sheet are shown in Table 3.

### Example 32

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 70 parts by mass of a urethane-based polymer (PANDEX™ T-5275N, product of Dainippon Ink & Chemicals, Inc.). The evaluation results for the obtained sheet are shown in Table 3.

### Example 33

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 100 parts by mass of an ethylene-vinyl acetate-carbon monoxide terpolymer (ELVALOY™ 741, product of Mitsui-DuPont Polychemicals Co., Ltd.). The evaluation results for the obtained sheet are shown in Table 3.

### Example 34

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 100 parts by mass of an ethylene-acrylic acid ester-carbon monoxide terpolymer (ELVALOY™ HP553, product of Mitsui-DuPont Polychemicals Co., Ltd.), and the coating solution of Composition 19 shown above for the stainproof layer was replaced with that of Composition 20 shown below. The evaluation results for the obtained sheet are shown in Table 3.

### Composition 20

| Component | Parts by mass |
|---|---|
| Vinylidene fluoride-chlorotrifluoroethylene | 30 |
| copolymer resin | |
| Acrylic resin | 45 |
| (LUCKSKIN ™ Z-290A, solid concentration: | |
| 17 wt %, product of Seiko Kasei Co., Ltd.) | |
| Wet precipitated fine silica particles | 25 |
| (NIPSIL ™ E-200, BET specific surface area: | |
| 120 m²/g, mean aggregate particle size: | |
| 3.0 μm, product of Nippon Silica Industrial | |
| Co., Ltd.) | |

[Note:
All parts are by mass in terms of solid content]

### Example 35

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 60 parts by mass of diisononyl phthalate (molecular weight: 418). The evaluation results for the obtained sheet are shown in Table 3.

### Example 36

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 60 parts by mass of di-2-ethylhexyl phthalate (molecular weight: 390). The evaluation results for the obtained sheet are shown in Table 3.

### Example 37

A stainproof, waterproof sheet was produced in the same manner as in Example 25, except that the diisodecyl phthalate (60 parts by mass) used as the plasticizer in the polyvinyl chloride resin film of Composition 18 shown above for the waterproof resin layer was replaced with 60 parts by mass of diheptyl phthalate (molecular weight: 362). The evaluation results for the obtained sheet are shown in Table 3.

### Example 38

A stainproof, waterproof sheet of the present invention was fabricated in the same manner as in Example 25, except that the waterproof resin layer was coated with a coating solution of Composition 21 shown below by using a gravure coater, and dried at 120° C. for 2 minutes to form an additive migration-preventing layer having a dry mass of 4 g /m², and a stainproof layer of Composition 19 shown above was formed on the additive migration-preventing layer. The evaluation results for the obtained sheet are shown in Table 3.

### Composition 21

| Component | Parts by mass |
|---|---|
| Primary amino group-containing acryl resin | 100 |
| (POLYMENT ™ NK-380, solid concentration: | |
| 30 wt %, product of Nippon Shokubai Co., | |
| Ltd.) | |
| Bisphenol A type epoxy resin | 10 |
| (EPIKOTE ™ 828, product of Yuka Shell Co., | |
| Ltd.) | |

[Note:
All parts are by mass in terms of solid content]

### Example 39

The same polyester non-coarse woven fabric as in Example 1 was employed as a base fabric, then both the front and back surfaces of the base fabric were coated with an acryl resin dispersion of Composition 22 shown below for the waterproof resin layer and heat-treated at 180° C. for 5 minutes, to form waterproof resin layers having a total dry weight of 200 g/m² , and to obtain a substrate sheet.

### Composition 22

| Component | Parts by wt. |
|---|---|
| Acryl resin for past-processing | 100 |
| (ZEON ACRYL RESIN ™ F320, product of Nihon | |
| Zeon Corporation) | |
| Tricresyl phosphate (melting point class: 4) | 60 |
| Tributyl acetyl citrate | 20 |
| Rutile titanium dioxide | 5 |
| Hindered phenol-based antioxidant | 0.2 |
| Cyano acrylate-based ultraviolet ray absorber | 0.2 |

The waterproof resin layer was coated with a coating solution of Composition 21 shown above for an additive migration-preventing layer, by using a gravure coater, and dried at 120° C. for 2 minutes to form an additive migration-preventing layer having a dry weight of 4 g/m², and the additive migration-preventing layer was coated with a coating solution of Composition 19 shown above for a stainproof layer by using a gravure coater to form a stainproof layer having a dry mass of 4 g m², thus to produce a stainproof waterproof sheet of the present invention. The evaluation results for the obtained sheet are shown in Table 3.

### Example 40

Using the same polypropylene non-coarse woven fabric as used in Example 19, as a base fabric, both the front and back surfaces of the base fabric were laminated with styrene-based elastomer resin films of Composition 23 shown below, shaped to a thickness of 0.2 mm by calender treatment, to form waterproof resin layers and to fabricate a substrate sheet.

### Composition 23

| Component | Parts by wt. |
|---|---|
| Styrene-based elastomer | 100 |
| (SEPTON ™ 4033, product of Kuraray Co., Ltd.) | |
| Paraffin-based process oil | 40 |
| Fine amorphous silica particles | 10 |
| (NIPSIL ™ NA, product of Nippon Silica | |
| Industrial Co., Ltd.) | |
| Rutile titanium dioxide | 5 |
| Hindered phenol-based antioxidant | 0.2 |
| Phosphoric acid ester-based lubricant | 0.2 |

Both the surfaces of the front and back surface waterproof resin layers were coated with a coating solution of Composition 24 shown below for an additive migration-preventing layer by using a gravure coater, and dried at 120° C. for 2 minutes, to form an additive migration-preventing layer having a dry mass of 4 g/m², and to fabricate a substrate sheet.

### Composition 24

| Component | Parts by wt. |
|---|---|
| Styrene-methyl methacrylate copolymer resin | 100 |
| Hexamethylene diisocyanate | 5 |

[Note:
All parts are by mass in terms of solid content]

Both the front and back surfaces of the substrate sheet were coated with a coating solution of Composition 19 shown above for a stainproof layer by using a gravure coater, and dried at 120° C. for 2 minutes, to form a stainproof layer having a dry mass of 4 g/m², and to fabricate a stainproof waterproof sheet of the present invention. The evaluation results for the obtained sheet are shown in Table 3.

### Example 41

A stainproof, waterproof sheet was produced in the same manner as in Example 25, except that the wet precipitated fine silica particles (25 parts by mass) in the coating solution of Composition 19 shown above for the stainproof layer were replaced with dry-produced fine silica particles having a BET specific surface area of 200 m²/g (AEROSIL™ TT-600, mean primary particle size of 12 nm, product of Nippon Aerosil Co., Ltd.) and the dry-produced fine silica particles were employed in an amount of 10 parts by mass, and the amount of acrylic resin added was changed from 75 parts to 90 parts by mass. The evaluation results for the obtained sheet are shown in Table 3.

### Example 42

A stainproof waterproof sheet was fabricated in the same manner as in Example 25, except that the wet precipitated silica fine particles (25 parts by mass) in the coating solution of Composition 19 shown above for the stainproof layer were replaced with dry-produced fine silica particles having a BET specific surface area of 200 m²/g (AEROSIL™ TT-600, mean primary particle size: 12 nm, product of Nippon Aerosil Co., Ltd.), the dry-produced fine silica particles were employed in an amount of 60 parts by mass, and the amount of acrylic resin was changed from 75 parts to 40 parts by mass. The evaluation results for the obtained sheet are shown in Table 3.

### Comparative Example 5

A comparison sheet was fabricated in the same manner as in Example 25, except that the amount of wet precipitated fine silica particles added to the coating solution of Composition 19 shown above for the stainproof layer was changed from 25 parts by mass to 5 parts by mass, and the amount of acrylic resin was changed from 75 parts by mass to 95 parts by mass. The evaluation results for the obtained sheet are shown in Table 3.

### Comparative Example 6

A comparison sheet was fabricated in the same manner as in Example 25, except that the amount of wet precipitated fine silica particles added to the coating solution of Composition 19 shown above for the stainproof layer was changed from 25 parts by mass to 65 parts by mass, and the amount of acrylic resin was changed from 75 parts by mass to 35 parts by mass. The evaluation results for the obtained sheet are shown in Table 3.

TABLE 3

| | | | | | Stainproof layer | | | | | |
|---|---|---|---|---|---|---|---|---|---|---|
| | | | | | | Amorphous silica fine particles | | | | |
| | | | | Addi- | | | BET | | | |
| | | | | tive | | | spec- | | | |
| | Substrate sheet | | | migra- | | | ific | | Mean | |
| | | Waterproof resin layer | | tion- | | | sur- | Mean | secon- | |
| | | Synthetic | | preven- | | | face | primary | dary | Amount |
| | Fiber | resin | Plasticizer or | ting | Synthetic resin | | area | particle | particle | added |
| | type | type | softener | layer | type | Type | (m²/g) | size | size | (wt %) |
| Exam- | | | | | | | | | | |
| ple | | | | | | | | | | |
| 25 | polyester | PVC | DIDP | None | acryl | wet | 120 | — | 3.0 μm | 25 |
| | | | | | resin | precipitation | | | | |
| 26 | polyester | PVC | DIDA | None | acryl | wet | 120 | — | 3.0 μm | 25 |
| | | | | | resin | precipitation | | | | |
| 27 | polyester | PVC | epoxidized | None | acryl | wet | 120 | — | 3.0 μm | 25 |
| | | | soybean oil | | resin | precipitation | | | | |
| 28 | polyester | PVC | trimellitic | None | acryl | wet | 120 | — | 3.0 μm | 25 |
| | | | acid ester | | resin | precipitation | | | | |
| 29 | polyester | PVC | pyromellitic | None | acryl | wet | 120 | — | 3.0 μm | 25 |
| | | | acid ester | | resin | precipitation | | | | |
| 30 | polyester | PVC | pentaerythritol | None | acryl | wet | 120 | — | 3.0 μm | 25 |
| | | | ester | | resin | precipitation | | | | |
| 31 | polyester | PVC | polyester | None | acryl | wet | 120 | — | 3.0 μm | 25 |
| | | | | | resin | precipitation | | | | |
| 32 | polyester | PVC | urethane | None | acryl | wet | 120 | — | 3.0 μm | 25 |
| | | | polymer | | resin | precipitation | | | | |
| 33 | polyester | PVC | ethylene-vinyl | None | acryl | wet | 120 | — | 3.0 μm | 25 |
| | | | acetate-carbon | | resin | precipitation | | | | |
| | | | monoxide | | | | | | | |
| | | | copolymer | | | | | | | |
| 34 | polyester | PVC | ethylene- | None | acryl | wet | 120 | — | 3.0 μm | 25 |
| | | | methacrylic | | resin | precipitation | | | | |
| | | | acid ester- | | fluorine- | | | | | |
| | | | carbon monoxide | | containing resin | | | | | |
| | | | copolymer | | | | | | | |
| 35 | polyester | PVC | DINP | None | acryl | wet | 120 | — | 3.0 μm | 25 |
| | | | | | resin | precipitation | | | | |
| 36 | polyester | PVC | DOP | None | acryl | wet | 120 | — | 3.0 μm | 25 |
| | | | | | resin | precipitation | | | | |
| 37 | polyester | PVC | DHP | None | acryl | wet | 120 | — | 3.0 μm | 25 |
| | | | | | resin | precipitation | | | | |
| 38 | polyester | PVC | DIDP | Formed | acryl | wet | 120 | — | 3.0 μm | 25 |
| | | | | | resin | precipitation | | | | |
| 39 | polyester | acryl | TCP, ATBC | Formed | acryl | wet | 120 | — | 3.0 μm | 25 |
| | | resin | | | resin | precipitation | | | | |
| 40 | poly- | styrene- | process oil | Formed | acryl | wet | 120 | — | 3.0 μm | 25 |
| | propylene | based | | | resin | precipitation | | | | |
| | | elastomer | | | | | | | | |
| 41 | polyester | PVC | DIDP | None | acryl | dry | 200 | 12 nm | — | 10 |
| | | | | | resin | | | | | |
| 42 | polyester | PVC | DIDP | None | acryl | dry | 200 | 12 nm | — | 60 |
| | | | | | resin | | | | | |
| Com- | | | | | | | | | | |
| para- | | | | | | | | | | |
| tive | | | | | | | | | | |
| Exam- | | | | | | | | | | |
| ple | | | | | | | | | | |
| 5 | polyester | PVC | DIDP | None | acryl | wet | 120 | — | 3.0 μm | 5 |
| | | | | | resin | precipitation | | | | |
| 6 | polyester | PVC | DIDP | None | acryl | wet | 120 | — | 3.0 μm | 65 |
| | | | | | resin | precipitation | | | | |

| Evaluation results | | | |
|---|---|---|---|
| Heat | | Stainproof property | |
| loss | | | Rain |
| of | | Lightness | streaking |
| base | Abrasion resistance | difference (ΔL) | stain |

| | sheet | 9.81 N × 500 | 9.81 N × 1000 | After 6 | | After 12 | | After | After |
|---|---|---|---|---|---|---|---|---|---|
| | (%) | times | times | months | | months | | 6 mos. | 12 mos. |
| Example | | | | | | | | | |
| 25 | 0.25 | ◯ | ◯ | ◯ | −3.5 | ◯ | −4.8 | ◯ | ◯ |
| 26 | 0.30 | ◯ | ◯ | ◯ | −3.5 | ◯ | −4.9 | ◯ | ◯ |
| 27 | 0.28 | ◯ | ◯ | ◯ | −3.5 | ◯ | −4.8 | ◯ | ◯ |
| 28 | 0.18 | ◯ | ◯ | ◯ | −3.4 | ◯ | −4.6 | ◯ | ◯ |
| 29 | 0.13 | ◯ | ◯ | ◯ | −3.4 | ◯ | −4.5 | ◯ | ◯ |
| 30 | 0.14 | ◯ | ◯ | ◯ | −3.5 | ◯ | −4.6 | ◯ | ◯ |
| 31 | 0.09 | ◯ | ◯ | ◯ | −3.3 | ◯ | −4.4 | ◯ | ◯ |
| 32 | 0.05 | ◯ | ◯ | ◯ | −3.2 | ◯ | −4.3 | ◯ | ◯ |
| 33 | 0.05 | ◯ | ◯ | ◯ | −3.0 | ◯ | −4.1 | ◯ | ◯ |
| 34 | 0.05 | ◯ | ◯ | ◯ | −2.9 | ◯ | −3.9 | ◯ | ◯ |
| 35 | 0.50 | ◯ | ◯ | ◯ | −3.8 | Δ | −5.5 | ◯ | ◯ |
| 36 | 0.91 | ◯ | ◯ | ◯ | −4.1 | Δ | −6.5 | ◯ | Δ |
| 37 | 1.42 | ◯ | ◯ | ◯ | −4.5 | Δ | −7.2 | ◯ | Δ |
| 38 | 0.24 | ◯ | ◯ | ◯ | −3.3 | ◯ | −4.4 | ◯ | ◯ |
| 39 | 0.95 | ◯ | ◯ | ◯ | −3.4 | ◯ | −4.8 | ◯ | ◯ |
| 40 | 0.10 | ◯ | ◯ | ◯ | −3.5 | ◯ | −4.9 | ◯ | ◯ |
| 41 | 0.25 | ◯ | ◯ | ◯ | −4.7 | Δ | −7.4 | ◯ | Δ |
| 42 | 0.25 | ◯ | Δ | ◯ | −3.7 | Δ | −5.8 | ◯ | Δ |
| Comparative | | | | | | | | | |
| Example | | | | | | | | | |
| 5 | 0.25 | ◯ | ◯ | Δ | −5.5 | Δ | −8.0 | Δ | x |
| 6 | 0.25 | Δ | Δ | ◯ | −4.1 | Δ | −8.7 | ◯ | x |

As is clear from Table 3, the sheets of Examples 25 to 42, though containing a plasticizer or softener in the waterproof resin layer, exhibited a satisfactory stainproof property due to adjustment of the amorphous silica fine particle content in the stainproof layer. Particularly the sheets of Examples 25 to 34, in which low-volatile plasticizers or high molecular plasticizers were contained in the waterproof resin layers, exhibited a particularly satisfactory antifouling property. The sheet of Example 38 hade an additive migration-preventing layer and therefore exhibited an excellent stainproof property compared to the sheet of Example 25 which had no additive migration-preventing layer. On the other hand, the sheets of Comparative Examples 5 and 6 had amorphous silica fine particle contents in the stainproof layer that were outside of the preferred range, and therefore exhibited an inferior stainproof property.

For the following Examples 43 to 47, the stainproof, waterproof sheets were wound into rolls and the stainproof property thereof was measured and evaluated by the following method.

5. Evaluation of Stainproof Property after Roll Wrapping into Roll and Accelerated Test

A sheet specimen was wound up around a cardboard cylinder having a diameter of 5.08 cm in such a manner that the stainproof layer came inside of the roll (sheet length: 40 cm), to obtain a rolled stainproof, waterproof sheet of the present invention. The roll was allowed to stand for 2 weeks in an oven to controlled a temperature of 50° C., and arelative humidity of 90% for an accelerated test. Table 4 shows the evaluation results of the stainproof property of the sheet after the accelerated test.

### Example 43

The evaluation results for the rolled stainproof, waterproof sheet of Example 1 are shown in Table 4.

### Example 44

The evaluation results for the rolled stainproof, waterproof sheet of Example 25 are shown in Table 4.

### Example 45

The evaluation results for the rolled stainproof, waterproof sheet of Example 34 are shown in Table 4.

### Example 46

A stainproof, waterproof sheet of the present invention was obtained in the same manner as in Example 25, except that the stainproof layer of Composition 19 was formed on both the surfaces of the front and back side waterproof resin layers. The evaluation results for the rolled sheet are shown in Table 4.

### Example 47

A stainproof, waterproof sheet of the present invention was obtained in the same manner as in Example 38, except that the additive migration-preventing layer of Composition 21 was formed on the surfaces of the front and back side waterproof resin layers, (and a stainproof layer was formed on only one side). The evaluation results for the rolled sheet are shown in Table 4.

TABLE 4

| | | | | | Stainproof layer | | | |
|---|---|---|---|---|---|---|---|---|
| | Substrate sheet | | | | | | Amorphous silica fine particles | |
| | | Waterproof resin | | | | Stain- | | BET |
| | | layer | | Additive | | proof | | specific |
| | | Synthetic | | migration- | | layer- | | surface |
| | Fiber | resin | Plasticizer | preventing | Synthetic | formed | | area |
| Example | type | type | or softener | layer | resin type | side | Type | (m²/g) |
| 43 | polyester | poly- | None | None | poly- | surface | wet | 120 |
| | | urethane | | | urethane | | precipitation | |
| 44 | polyester | PVC | DIDP | None | acryl resin | surface | wet | 120 |
| | | | | | | | precipitation | |
| 45 | polyester | PVC | ethylene- | None | acryl resin | surface | wet | 120 |
| | | | methacrylic | | fluorine- | | precipitation | |
| | | | acid ester- | | containing | | | |
| | | | carbon | | resin | | | |
| | | | monoxide | | | | | |
| | | | copolymer | | | | | |
| 46 | polyester | PVC | DIDP | None | acryl resin | both | wet | 120 |
| | | | | | | sides | precipitation | |
| 47 | polyester | PVC | DIDP | Formed | acryl resin | surface | wet | 120 |
| | | | | | | | precipitation | |

| Stainproof layer | | | Evaluation results | | |
|---|---|---|---|---|---|
| Amorphous silica fine particles | | | | Stainproof property | |
| Mean | Mean | | Acceler- | Lightness | Rain |
| primary | secondary | Amount | ated test | difference (ΔL) | streaking stain |

| | particle | particle | added | period | After 6 | | After 12 | | After | After |
|---|---|---|---|---|---|---|---|---|---|---|
| Example | size | size | (wt %) | for roll | months | | months | | 6 mos. | 12 mos. |
| 43 | — | 3.0 μm | 25 | 2 weeks | 3 | −2.6 | 3 | −3.6 | 3 | 3 |
| 44 | — | 3.0 μm | 25 | 3 days | 3 | −3.8 | 2 | −5.2 | 3 | 3 |
| | | | | 2 weeks | 2 | −5.1 | 2 | −7.5 | 3 | 2 |
| 45 | — | 3.0 μm | 25 | 2 weeks | 3 | −3.3 | 3 | −4.5 | 3 | 3 |
| 46 | — | 3.0 μm | 25 | 2 weeks | 3 | −3.5 | 3 | −4.9 | 3 | 3 |
| 47 | — | 3.0 μm | 25 | 2 weeks | 3 | −3.4 | 3 | −4.7 | 3 | 3 |

In Table 4, the wound roll of the sheet of Example 43 contained no plasticizer or softener in the waterproof resin layer, and therefore the stainproof property was satisfactory after the accelerated test. The wound roll of the sheet of Example 44 contained a plasticizer in the waterproof resin layer and therefore exhibited a satisfactory stainproof property for a short accelerated test period, but a reduction in stainproof property and rain streaking resistance was found with a prolonged accelerated test period. The wound roll of the sheet of Example 45 employed a high molecular plasticizer in the waterproof resin layer and therefore exhibited virtually no reduction in antifouling property. The wound roll of the sheet of Example 46 employed the same plasticizer as Example 44, but since the stainproof layer was formed on both the sides of the substrate sheet, virtually no reduction in antifouling property was exhibited in the accelerated test. The wound roll of the sheet of Example 47 had an additive migration-preventing layer formed on the back side of the sheet, and therefore exhibited virtually no reduction in stainproof property in the accelerated test.

The welding joint durability of each of the antifouling waterproof sheets of Examples 1, 20, 21, 25 and 40 was measured and evaluated by the following method.

6. Evaluation of Durability of Joined Portions

Two pieces of the test sheet were joined front to back with a joint width of 3 cm using a high-frequency welder, and the durability of the joined portions was evaluated by a creep test conducted for a 3 cm-wide, 30 cm-long test strip cut out in a rectangular form along a yarn direction perpendicular to the joined portion, and the joined portion was positioned at the center of the test strip. The test was conducted for 24 hours at the joined portion of the test strip at, an atmosphere temperature of 65° C. under an applied load of 196 N/3 cm (20 kgf/3 cm). The evaluation was made based on the following scale. The evaluation results are shown in Table 5.
2:Normal

1:Abnormal (separation of joined pieces)

TABLE 5

| | Example | | | | |
|---|---|---|---|---|---|
| | 1 | 20 | 21 | 25 | 40 |
| Durability | 2 | 2 | 2 | 2 | 2 |
| of joint | | | | | |

The stainproof, waterproof sheets of the present invention exhibited satisfactory weldability and joint durability, and were therefore adequately suitable for use as large-area spreading surface materials for medium and large-sized tents, tent storehouses, and the like.

In the following Examples 48 to 53, the flameproofness of each of the flame retardant, stainproof, waterproof sheets was evaluated by the method described below.

7. Flameproofness Evaluation

The test sheet was subjected to a flameproof test according to JIS L 1091 (Method A2) and according to JIS A 1322 for evaluation of the flameproofness. The evaluation was made based on the following scale. The results are shown in Table 6.

(A) JIS L 1091

2:Pass (char area≦40 cm², afterflame time:5 seconds or less, afterglow time:20 seconds or less, char length:20 cm or less)

1:Fail (in any one of char area, afterflame time, afterglow time and char length)

(B) JIS A 1322

2:Pass Grade 2 flameproofness (char length:10 cm or less, afterflame time:5 seconds or less, afterglow time 60 seconds or less)

1:Fail (in any one of char length, afterflame time and afterglow time)

### Example 48

The same polyester non-coarse woven fabric as used in Example 1 was used as a base fabric, both the front and back surfaces of the base fabric were laminated with a waterproof resin layer polyester film of Composition 25 shown below, to form waterproof resin layers and to fabricate a substrate sheet the film was produced in a thickness of 0.2 mm by using an extrusion molder (T-die). The flameproofness of the sheet was evaluated. The evaluation results for the obtained sheet are shown in Table 6.

### Composition 25

| Component | Parts by mass |
|---|---|
| Polyester resin | 100 |
| (PELPRENE ™ P-40B, product of Toyobo Co., | |
| Ltd.) | |
| 1,3-Phenylenebis(diphenyl phosphate) condensate | 20 |
| (REOFOS ™ RDP, melting temperature class: 4, | |
| product of Ajinomoto Fine-Techno Co., Inc.) | |
| Rutile titanium dioxide | 5 |
| Hindered phenol-based antioxidant | 0.2 |
| Carbodiimide (hydrolysis inhibitor) | 0.5 |
| (STABAXOL ™ P-100, product of Sumitomo | |
| Bayer Urethane Co., Ltd.) | |
| Polyolefin-based lubricant | 0.2 |

One surface of the substrate sheet was coated with a coating solution of Composition 26 shown below by using a gravure coater, and dried at 140° C. for 2 minutes, to form a stainproof layer having a dry mass of 4 g/m², to fabricate a stainproof waterproof sheet of the present invention. The evaluation results for the obtained sheet are shown in Table 6.

### Composition 26

| Component | Parts by mass |
|---|---|
| Polyester resin | 75 |
| (PESRESIN ™ S-110G, solid concentration: | |
| 30 mass %, product of Takamatsu Oil & Fat | |
| Co., Ltd.) | |
| Dry-method fine silica particles | 25 |
| (AEROSIL ™ 200, BET specific surface area: | |
| 200 m²/g, mean primary particle size: 30 nm, | |
| product of Nippon Aerosil Co., Ltd.) | |
| Carbodiimide (hydrolysis inhibitor) | 0.5 |
| (STABAXOL ™ P, Product of Sumitomo Bayer | |
| Urethane Co., Ltd.) | |

[Note:
All parts are by mass in terms of solid content]

### Example 49

A stainproof, waterproof sheet was fabricated in the same manner as in Example 48, except that, the 1,3-phenylene-bis(diphenyl phosphate) used as the flame retardant in the polyester film of Composition 25 shown above for the waterproof resin layer was replaced with 1,3-phenylenebis(dixylenyl phosphate) (ADEKASTAB™ FP-500, melting temperature class: 3, product of Asahi Glass Co., Ltd.). The evaluation results for the obtained sheet are shown in Table 6.

### Example 50

A stainproof, waterproof sheet was fabricated in the same manner as in Example 48, except that, the waterproof resin layer was coated with a coating solution of Composition 27 shown below by using a gravure coater and dried at 120° C. for 2 minutes to form an additive migration-preventing layer having a dry weight of 4 g/m², and a stainproof layer of Composition 26 shown above was formed on this additive migration-preventing layer. The evaluation results for the obtained sheet are shown in Table 6.

### Composition 27

| Component | Parts by mass |
|---|---|
| Polyester resin | 95 |
| (PESRESIN ™ S-110G, product of Takamatsu | |
| Oil & Fat Co., Ltd.) | |
| Hexamethylene diisocyanate | 5 |
| Carbodiimide (hydrolysis inhibitor) | 0.5 |
| (STABAXOL ™ P, Product of Sumitomo Bayer | |
| Urethane Co., Ltd.) | |

[Note:
All parts are by mass in terms of solid content.]

### Example 51

A stainproof, waterproof sheet was fabricated in the same manner as in Example 48, except that a coating solution of Composition 28 shown below was used to form an additive migration-preventing layer, and a coating solution of Composition 29 shown below was used to form a stainproof layer. The evaluation results for the obtained sheet are shown in Table 6.

### Composition 28

| Component | Parts by mass |
|---|---|
| Polyester resin | 85 |
| (PESRESIN ™ S-110G, product of Takamatsu | |
| Oil & Fat Co., Ltd.) | |
| Benzoguanamine/melamine/formaldehyde condensate | 10 |
| (EPOSTAR ™ M-30, mean particle size: 3 μm, | |
| melting point class: 1, product of Nippon | |
| Shokubai Co., Ltd.) | |
| Hexamethylene diisocyanate | 5 |
| Carbodiimide (hydrolysis inhibitor) | 0.5 |
| (STABAXOL ™ P, Product of Sumitomo Bayer | |
| Urethane Co., Ltd.) | |

[Note:
All parts are by mass in terms of solid content.]

### Composition 29

| Component | Parts by mass |
|---|---|
| Polyester resin | 75 |
| (PESRESIN ™ S-110G, product of Takamatsu | |
| Oil & Fat Co., Ltd.) | |
| Dry-method silica fine particles | 25 |
| (AEROSIL ™ 200, product of Nippon Aerosil | |
| Co., Ltd.) | |
| Magnesium hydroxide | 10 |
| (Kisuma ™ 5A, melting point class: 1, product | |
| of Kyowa Chemical Industry Co., Ltd.) | |
| Carbodiimide (hydrolysis inhibitor) | 0.5 |
| (STABAXOL ™ P, Product of Sumitomo Bayer | |
| Urethane Co., Ltd.) | |

[Note:
All parts are by mass in terms of solid content.]

### Example 52

A stainproof, waterproof sheet was fabricated in the same manner as in Example 51, except that a coating solution of Composition 30 shown below was used to form a stainproof layer. The evaluation results for the obtained sheet are shown in Table 6.

### Composition 30

| Component | Parts by mass |
|---|---|
| Polycarbonate-based polyurethane resin | 75 |
| (CRISVON ™ NY-331, Product of DAINIPPON INK | |
| AND CHEMICALS, INCORPORATED) | |
| Dry-method silica fine particles | 25 |
| (AEROSIL ™ 200, product of Nippon Aerosil | |
| Co., Ltd.) | |
| Magnesium hydroxide | 10 |
| (KISUMA ™ 5A, melting point class: 1, product | |
| of Kyowa Chemical Industry Co., Ltd.) | |

[Note:
All parts are by mass in terms of solid content.]

### Example 53

A stainproof, waterproof sheet was fabricated in the same manner as in Example 51, except that a coating solution of Composition 31 shown below was used to form a stainproof layer. The evaluation results for the obtained sheet are shown in Table 6.

### Composition 31

| Component | Parts by mass |
|---|---|
| Acryl resin | 80 |
| (Methyl methacrylate polymer/vinyl chloride- | |
| vinyl acetate copolymer = 60/40 blend, solid | |
| concentration: 15 mass %) | |
| Dry-method silica fine particles | 20 |
| (AEROSIL ™ 200, product of Nippon Aerosil | |
| Co., Ltd.) | |
| Magnesium hydroxide | 20 |
| (KISUMA ™ 5A, melting temperature class: 1, | |
| product of Kyowa Chemical Industry Co., Ltd.) | |

[Note:
All parts are by weight in terms of solid content.]

### Example 54

The same polypropylene non-coarse woven fabric as used in Example 19 was used as a base fabric. Both the front and back surfaces of the base fabric were laminated with polypropylene-based elastomer resin films (thickness: 0.20 mm) of Composition 32 shown below, shaped by a calender working, to form a waterproof resin layers and to fabricate a substrate sheet.

### Composition 32

| Component | Parts by mass |
|---|---|
| Polypropylene-based elastomer | 100 |
| Melamine cyanurate (melting point class: 1) | 50 |
| 1,3-phenylenebis(diphenyl phosphate) | 25 |
| (melting point class: 4) | |
| Rutile titanium dioxide | 5 |
| Hindered phenol-based antioxidant | 1.0 |

Both of the waterproof resin layers of the substrate sheet were coated with a coating solution of Composition 33 shown below by using a gravure coater, and dried at 120° C. for 2 minutes, to form front and back adhesive layers with a dry mass of 2 g/m², and then a coating solution of Composition 34 shown below was also coated onto the front and back adhesive layers to form front and back additive migration-preventing layers with a dry mass of 4 g/m².

### Composition 33

| Component | Parts by mass |
|---|---|
| Modified polyolefin resin | 100 |
| (UNISTOLE ™ P-801, solid concentration: | |
| 16 wt %, product of Mitsui Chemicals, Inc.) | |
| Melamine-coated polyammonium phosphate | 20 |
| (melting point class: 1) | |

[Note:
All parts are by mass in terms of solid content]

### Composition 34

| Component | Parts by mass |
|---|---|
| Modified polyolefin resin | 50 |
| (UNISTOLE ™ P-801, product of Mitsui | |
| Chemicals, Inc.) | |
| Primary amino group-containing acryl-based resin | 50 |
| (POLYMENT ™ NK-380, product of Nippon | |
| Shokubai Co., Ltd.) | |
| Magnesium hydroxide | 30 |
| (KISUMA ™ 5A, melting temperature class: 1, | |
| product of Kyowa Chemical Industry Co., Ltd.) | |

[Note:
All parts are by weight in terms of solid content.]

One of the additive migration-preventing layers of the substrate sheet was coated with a coating solution of Composition 35 shown below by using a gravure coater, to form a stainproof layer with a dry mass of 4 g/m² and to fabricate a stainproof waterproof sheet of the present invention. The evaluation results for the obtained sheet are shown in Table 6.

### Composition 35

| Component | Parts by mass |
|---|---|
| Acryl-based resin | 60 |
| (LUCKSKIN ™ Z-290A, product of Seiko Kasei | |
| Co., Ltd.) | |
| Modified polyolefin resin | 20 |
| (UNISTOLE ™ P-801, product of Mitsui | |
| Chemicals, Inc.) | |
| Dry-method silica fine particles | 20 |
| (AEROSIL ™ 200, product of Nippon Aerosil | |
| Co., Ltd.) | |
| Magnesium hydroxide | 20 |
| (KISUMA ™ 5A, melting temperature class: 1, | |
| product of Kyowa Chemical Industry Co., Ltd.) | |
| Rutile titanium dioxide | 1 |

[Note:
All parts are by mass in terms of solid content]

### Example 55

Using the same polyester non-coarse woven fabric as used in Example 1 as a base fabric, both the front and back surfaces of the base fabric were coated with a polyvinyl chloride resin dispersion of Composition 36 shown below and heat treated at 180° C. for 2 minutes to form front and back adhesive layers with a total dry weight of 300 g/m².

### Composition 36

| Component | Parts by mass |
|---|---|
| Polyvinyl chloride resin for pasting | 100 |
| Tris-2-ethylhexyl trimellitate | 80 |
| Epoxidized soybean oil | 3 |
| Organotin-based stabilizer | 2 |
| Magnesium hydroxide (melting point class: 1) | 20 |
| Antimony trioxide (melting point class: 1) | 20 |
| Rutile titanium dioxide | 10 |

One of the front and back adhesive layers was heat-laminated with a polyvinyl chloride resin film of Composition 37 shown below, shaped to a thickness of 0.12 mm by calender treatment, to fabricate a substrate sheet.

### Composition 37

| Component | Parts by mass |
|---|---|
| Polyvinyl chloride resin for calendering | 100 |
| Ethylene-vinyl acetate-carbon monoxide terpolymer | 100 |
| Epoxidized soybean oil | 10 |
| Mercaptotin-based stabilizer | 2 |
| Hindered phenol-based antioxidant | 0.2 |
| Magnesium hydroxide (melting temperature class: 1) | 5 |
| Antimony trioxide (melting temperature class: 1) | 10 |
| Rutile titanium dioxide | 10 |

Both the front and back surface of the substrate sheet were coated with a coating solution of Composition 38 shown below by using a gravure coater, to form front and back adhesive layers with a dry weight of 2 g/m². One of the adhesive layers (the waterproof resin layer-formed side) was then coated with a coating solution of Composition 39 shown below, to form an additive migration-preventing layer with a dry weight of 2 g/m², in the same manner as for the adhesive layer.

### Composition 38

| Component | Parts by mass |
|---|---|
| Acrylic resin | 100 |
| (SONYBOND ™ SC-474, solid content: 25 mass %, | |
| product of Sony Chemicals Corporation) | |

### Composition 39

| Component | Parts by wt. |
|---|---|
| Fluorine-modified acryl resin | 100 |
| (LUCKSKIN ™ Z-899, solid concentration: | |
| 10 mass %, product of Seiko Kasei Co., Ltd.) | |

The additive migration-preventing layer-formed surface was coated with a coating solution of Composition 40 shown below by using a gravure coater, to form a stainproof layer with a dry mass of 4 g/m², and to fabricate a stainproof, waterproof sheet of the present invention. The evaluation results for the obtained sheet are shown in Table 6.

### Composition 40

| Component | Parts by mass |
|---|---|
| Acryl based resin | 75 |
| (LUCKSKIN ™ Z-290A, product of Seiko Kasei | |
| Co., Ltd.) | |
| Dry-method silica fine particles | 25 |
| (AEROSIL ™ 200, product of Nippon Aerosil | |
| Co., Ltd.) | |

[Note:
All parts are by weight in terms of solid content]

### Example 56

A stainproof waterproof sheet of the invention was fabricated in the same manner as in Example 55, except that, (in terms of solid portion) all of the adhesive layer coating solution, the additive migration-preventing layer coating solution and the stainproof layer coating solution contained 20 parts by solid mass of aluminum hydroxide particles with a mean particle size of 3 μm (melting temperature class: 1). The evaluation results for the obtained sheet are shown in Table 6.

TABLE 6

| | | | Stainproof property | | | |
|---|---|---|---|---|---|---|
| | | | Lightness | | Rain | Joint |
| | Flameproofness | | difference | | streaking | dura- |
| | JIS | JIS | (after 10 | | (after 10 | bility |
| Example | L 1091 | A 1322 | months) | | months) | (*3) |
| 48 | 2 | 2 | 3 | −4.4 | 3 | 2 |
| 49 | 2 | 2 | 3 | −3.7 | 3 | 2 |
| 50 | 2 | 1 (*1) | 3 | −3.8 | 3 | 2 |
| 51 | 2 | 2 | 3 | −3.8 | 3 | 2 |
| 52 | 2 | 2 | 3 | −4.0 | 3 | 2 |
| 53 | 2 | 2 | 3 | −3.7 | 3 | 2 |
| 54 | 2 | 2 | 3 | −3.8 | 3 | 2 |
| 55 | 2 | 1 (*2) | 3 | −3.9 | 3 | 2 |
| 56 | 2 | 2 | 3 | −3.8 | 3 | 2 |

(*1) Unacceptable afterflame time with 10 seconds of
heating.
(*2) Unacceptable afterflame time with 30 seconds of
heating.
(*3) Welding was accomplished using a hot-air welder
(Leister Co., Ltd.) at 3 m/min at a hot air temperature
of 550° C.

As is clear from Table 6, the sheets of Examples 48 to 56 exhibited a satisfactory stainproof property. The sheet of Example 49 employed a flame retardant with a higher melting point than that in Example 48 and therefore exhibited an still more excellent stainproof property. The sheet of Example 50 contained the same flame retardant as for Example 48 but also had an additive migration-preventing layer formed, and therefore exhibited a still more excellent stainproof property. The sheets of Examples 51 to 53 contained flame retardants contained in the additive migration-preventing layer and the stainproof layer, and therefore exhibited not only an excellent stainproof property but also an excellent flameproofness. The sheets of Examples 54 and 56 contained flame retardants contained in all of the adhesive layer, the additive migration-preventing layer and the antifouling layer and therefore exhibited not only an excellent stainproof property, but also an excellent flameproofness.

### Industrial Applicability

The stainproof, waterproof sheets according to the present invention, which are provided with a stainproof layer containing fine amorphous silica particles, exhibit an excellent stainproof property and especially satisfactory rain streaking stain resistance. They can also have an excellent flame retardance. The stainproof, waterproof sheets of the present invention are very useful for practical use in industries, for example, medium and large-sized tents, tent storehouses, canopy tents, truck hoods, backlit signboards, etc., since they maintain an attractive outer appearance with no rain streaking stain, even for prolonged periods of use.

1. A stainproof, waterproof sheet comprising a substrate sheet comprising a base fabric comprising at least one fiber fabric, and a waterproof resin layer formed on at least one surface of the base fabric and containing a synthetic resin, and a stainproof layer formed on said waterproof resin layer of said substrate sheet and containing a synthetic resin and fine amorphous silica particles.

2. A stainproof, waterproof sheet according to claim 1, wherein the fine amorphous silica particles have a BET specific surface area of 40 to 500 m²/g.

3. A stainproof, waterproof sheet according to claim 1 or 2, wherein the fine amorphous silica particles comprise at least one member selected from fine amorphous silica particles produced by a dry method and a wet precipitation method.

4. A stainproof, waterproof sheet according to claim 1, wherein the stainproof layer contains the fine amorphous silica particles in a proportion of 5 to 70 mass % with respect to the total mass of the stainproof layer.

5. A stainproof, waterproof sheet according to claim 1, wherein the synthetic resin contained in the waterproof resin layer comprises at least one member selected from polyolefin resins, chlorinated polyolefin resins, ethylene-vinyl acetate copolymer resins, ethylene-(meth)acrylic acid ester copolymer resins, polyurethane resins, polyester resins, acrylic resins and tetrafluoroethylene-hexafluoropropylene-vinylidene fluoride terpolymer resins.

6. A stainproof, waterproof sheet according to claim 1, wherein the synthetic resin contained in the stainproof layer comprises at least one member selected from polyolefin resins, ethylene-vinyl acetate copolymer resins, ethylene-(meth)acrylic acid ester copolymer resins, fluorine atom-containing resins, acrylic resins, polyurethane resins and polyester resins.

7. A stainproof, waterproof sheet according to claim 1, wherein an adhesive layer is further formed between the waterproof resin layer and the stainproof layer.

8. A stainproof, waterproof sheet according to claim 1, wherein the waterproof resin layer further comprises a flame retardant agent.

9. A stainproof, waterproof sheet according to claim 1, wherein a front surface waterproof resin layer formed on the front surface of the base fabric further comprises an additive, and an additive migration-preventing layer is formed between the front surface waterproof resin layer and said stainproof layer.

10. A stainproof, waterproof sheet according to claim 1, wherein a back surface waterproof resin layer formed on the back surface of the base fabric further comprises an additive, and an additive migration-preventing layer is formed on the back surface waterproof resin layer.

11. A stainproof, waterproof sheet according to claim 9 or 10, wherein the additive migration-preventing layer comprises at least one synthetic resin selected from polyolefin resins, ethylene-vinyl acetate copolymer resins, ethylene-(meth)acrylic acid ester copolymer resins, fluorine atom-containing resins, acrylic resins, polyurethane resins and polyester resins.

12. A stainproof, waterproof sheet according to claim 9 or 10, wherein the additive contained in said waterproof resin layer is a flame retardant agent.

13. A stainproof, waterproof sheet according to claim 9 or 10, wherein the additive contained in the front surface- and/or back-surface waterproof resin layer contains a condensed phosphoric acid ester flame retardant agent.

14. A stainproof, waterproof sheet according to claim 1, wherein the stainproof layer further contains a flame retardant agent.

15. A stainproof, waterproof sheet according to claim 7, wherein said adhesive layer further contains a flame regardant agent.

16. A stainproof, waterproof sheet according to claim 9 or 10, wherein said additive migration-preventing layer further contains a flame retardant agent.

17. A stainproof, waterproof sheet according to claim 1, wherein the heat mass reduction of the substrate sheet measured according to JIS K-6732-1981 is 1.0% or less.

18. A stainproof, waterproof sheet according to claim 1, wherein the stainproof layer is one formed by coating a solution and/or dispersion of the synthetic resin containing fine amorphous silica particles.

19. A rolled stainproof, waterproof sheet, in which the stainproof, waterproof sheet according to claim 1 is wound up into a roll form.

20. A stainproof, waterproof sheet comprising a substrate sheet comprising a base fabric composed of at least one fiber fabric, and a waterproof resin layer formed on at least one surface of the base fabric, and containing a synthetic resin and a plasticizer and/or softner, and stainproof layer comprising a synthetic resin and fine amorphous silica particles, and formed on the waterproof resin layer of said substrate sheet, wherein the stainproof layer contains the fine amorphous silica particles in a proportion of 10 to 60 mass % based on the total mass of the stainproof layer.

21. A stainproof, waterproof sheet according to claim 20, wherein the fine amorphous silica particles have a BET specific surface area of 40 to 500 m²/g.

22. A stainproof, waterproof sheet according to claim 20 or 21, wherein the fine amorphous silica particles comprise at least one member of fine amorphous silica particles produced by a dry method and a wet precipitation method.

23. A stainproof, waterproof sheet according to claim 20, wherein the waterproof resin layer comprises a polyvinyl chloride resin and at least one type of plasticizer selected from phthalic acid ester platicizers having a molecular weight of 400 or more, aliphatic dibasic acid ester platicizers having a molecular weight of 420 or more, trimellitic acid ester platicizers, pyromellitic acid ester platicizers, dipentaerythritol ester plasticizers, epoxide plasticizers, polyester plasticizers having a molecular weight of 600 or more, ester-type urethane polymer plasticizers, ethylene-vinyl acetate-carbon monoxide terpolymer plasticizers and ethylene-(meth)acrylic acid ester-carbon monoxide terpolymer plasticizers.

24. A stainproof, waterproof sheet according to claim 20, wherein the synthetic resin contained in said waterproof resin layer is selected from acrylic resins.

25. A stainproof, waterproof sheet according to claim 20, wherein the synthetic resin contained in the stainproof layer comprises at least one member selected from fluorine atom-containing resins, acrylic resins, polyurethane resins and polyester resins.

26. A stainproof, waterproof sheet according to claim 20, wherein an adhesive layer is formed between the waterproof resin layer and the stainproof layer.

27. A stainproof, waterproof sheet according to claim 20, wherein additive migration-preventing layer is formed between the waterproof resin layer and the stainproof layer.

28. A stainproof, waterproof sheet according to claim 20, wherein a back surface waterproof resin layer is formed on the back surface of the base fabric, and an additive migration-preventing layer is formed on the back surface waterproof resin layer.

29. A stainproof, waterproof sheet according to claim 27 or 28, wherein the additive migration-preventing layer comprises at least one synthetic resin selected from fluorine atom-containing resins, acrylic resins, polyurethane resins, cyanoethylated ethylene-vinyl alcohol copolymer resins and polyester resins.

30. A stainproof, waterproof sheet according to claim 20, wherein the waterproof resin layer further comprises a flame retardant agent.

31. A stainproof, waterproof sheet according to claim 20, wherein the stainproof layer further comprises a flame retardant agent.

32. A stainproof, waterproof sheet according to claim 26, wherein said adhesive layer further comprises a flame retardant agent.

33. A stainproof, waterproof sheet according to claim 27 or 28, wherein said additive migration-preventing layer further comprises a flame retardant agent.

34. A stainproof, waterproof sheet according to claim 20, wherein a heat mass reduction of said substrate sheet measured according to JIS K-6732-1981 is 1.0% or less.

35. A stainproof, waterproof sheet according to claim 20, wherein the stainproof layer is one formed by coating a solution and/or dispersion of the synthetic resin containing the fine amorphous silica particles.

36. A rolled stainproof, waterproof sheet, in which a stainproof, waterproof sheet according to claim 20 is wound up into a roll form.
